(19) United States
(12) Patent Application Publication
(10) Pub. No.: US 2025/0005572 A1
(43) Pub. Date: Jan. 2, 2025

(54) DIGITAL ASSET-BASED INTERACTION VIA AN INTERACTION COMPUTING ENTITY

(71) Applicant: Flexa Inc., New York, NY (US)

(72) Inventors: Trevor Filter, New York, NY (US); Zachary Kilgore, Brooklyn, NY (US)

(73) Assignee: Flexa Inc., New York, NY (US)

(21) Appl. No.: 18/754,532

(22) Filed: Jun. 26, 2024

Related U.S. Application Data
(60) Provisional application No. 63/523,936, filed on Jun. 29, 2023.

(51) Int. Cl. G06Q 20/40; G06Q 30/0207

(52) U.S. Cl. CPC G06Q 20/401; G06Q 30/0207

(57) ABSTRACT

A method for a secure interaction includes initiating, by a source or destination computing entity, a secure interaction between them regarding something of value, which includes informing an interaction computing entity of the initiated secure transaction. The method further includes determining, by the interaction computing entity, user preferences associated with the source computing entity based on a set of source inputs. The method further includes determining, by the interaction computing entity, merchant preferences associated with the destination computing entity. The method further includes establishing, by the interaction computing entity, digital asset exchange parameters for the secure interaction based on the user preferences and on the merchant preferences. The method further includes facilitating, by the interaction computing entity, the secure interaction between the source and destination computing entities based on the digital asset exchange parameters when the digital asset exchange parameters were confirmed by the source and/or the destination computing entities.

### CROSS-REFERENCE TO RELATED APPLICATIONS

The present U.S. Utility Patent Application claims priority pursuant to 35 U.S.C. § 119(e) to U.S. Provisional Application No. 63/523,936, entitled “Fractionalization of Data in a Digital Asset-Based Interaction System”, filed Jun. 29, 2023; all of which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to a digital asset-based interaction system and more specifically to fractionalization of data in a digital asset-based interaction.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity have their own varying security limitations. The steps involved are also inconvenient, time consuming, and expensive. For example, payment card authorization (e.g., credit or debit card authorization) begins with the cardholder presenting the payment card to a merchant for goods or service.

The payment card is issued by a particular financial institution (e.g., a bank) and is associated with a payment card network (e.g., Visa, Mastercard, etc.). The merchant uses a payment card machine, software, or gateway to transmit transaction data to their acquiring bank (or its processor). The acquiring bank routes the transaction data to a payment processing network, and the payment processing network sends the transaction data to the cardholder's issuing bank. The issuing bank validates that the card has not been reported stolen or lost, confirms whether funds/credit is available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. A response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees, and those costs are passed along to consumers in the form of higher prices. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Traditional bank account-linked mobile wallet applications allow cardholders to store payment card data on a computing device via a digital wallet for more convenient transactions. For example, some mobile wallet apps use near field communication (NFC) for contactless payments (e.g., exchange of data by holding a device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights. Distributed ledger technology (DLT) is a digital system that provides a consensus of replicated, shared, and synchronized digital data spread across several nodes. Unlike traditional databases, DLTs often lack central authority. The nodes of a DLT implement a verification process such as a consensus method to validate the authenticity of transactions recorded in the ledger.

Distributed ledger technology reduces the risk of fraudulent activity in creating and executing transactions (e.g., such as payments). For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

A cryptocurrency is a digital asset that is securely created and transferred via cryptography. Many cryptocurrencies exist on distributed networks based on DLT (e.g., a blockchain). Decentralized networks like Bitcoin use pseudo-anonymous transactions that are open and public (i.e., anyone can join, create, and view transactions). To eliminate fraudulent transactions and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

### BRIEF DESCRIPTION OF THE SEVERAL VIEWS OF THE DRAWING(S)

FIG. 1 is a schematic block diagram of an embodiment of a digital asset-based interaction system;

FIG. 2 is a schematic block diagram of another embodiment of a digital asset-based interaction system;

FIG. 3 is a schematic block diagram of another embodiment of a digital asset-based interaction system;

FIG. 4 is a schematic block diagram of an embodiment of a portion of the digital asset-based interaction system;

FIG. 5 is a schematic block diagram of an embodiment of a portion of a digital asset-based interaction system;

FIG. 6 is a schematic block diagram of a source computing entity and a digital asset-based interaction computing entity of a digital asset-based interaction system;

FIG. 7 is a schematic block diagram of an embodiment of exchanging access tokens between one or more computing entities of the digital asset-based interaction system;

FIG. 8 is a schematic block diagram of an embodiment of a digital asset-based interaction computing entity and a source computing entity of the digital asset-based interaction system;

FIG. 9 is a flowchart of an example of a method of facilitating a digital asset-based interaction via a digital asset-based interaction page;

FIG. 9A is a flowchart of an example of a method of facilitating a digital asset-based interaction via a digital asset-based interaction page;

FIG. 9B is a flowchart of an example of a method of facilitating a digital asset-based interaction via a digital asset-based interaction page;

FIG. 9C is a logic diagram of an example of a method for a secure interaction;

FIG. 10 is a flowchart of an example of a method of a digital asset-based interaction computing entity facilitating a digital asset-based interaction between a source computing entity and a destination computing entity;

FIG. 11 is a flowchart of an example of a method of a real-time digital asset-based interaction process;

FIG. 12 is a flowchart of an example of a method of a nonreal-time digital asset-based interaction process;

FIG. 13 is a flowchart of an example of a method of a real-time digital asset-based interaction process;

FIG. 14 is a flowchart of an example of a method of a real-time digital asset-based interaction process;

FIG. 15 is a flowchart of an example of a method of a real-time digital asset-based interaction process;

FIGS. 16A-16C are flowcharts of an example of a method of a nonreal-time digital asset-based interaction process;

FIG. 17 is a flowchart of an example of a method of a digital asset-based interaction using a digital asset pushing request

FIG. 18 is a schematic block diagram of an embodiment of a source computing entity;

FIG. 19 is a schematic block diagram of an embodiment of source computing entity;

FIGS. 20A-20C are schematic block diagrams of embodiments of asset management units;

FIG. 21 is a flowchart of an example of a method of a real-time purchase of digital assets using cash of a digital asset-based interaction system; and

FIG. 22 is a schematic block diagram of a multi-party interaction of a digital asset-based interaction system.

### DETAILED DESCRIPTION OF THE INVENTION

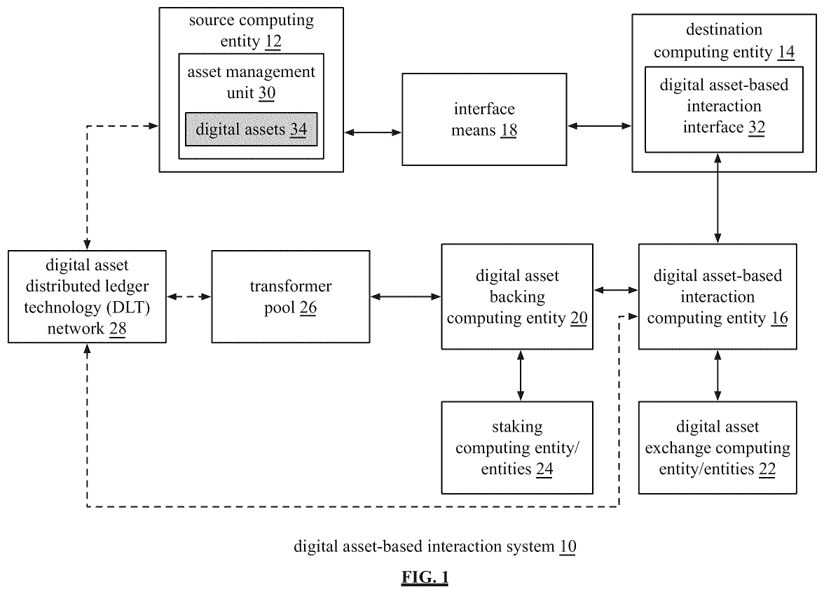

FIG. 1 is schematic block diagram of an embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, at least one transformer pool 26, and at least one digital asset distributed ledger technology (DLT) network 28.

The digital asset-based interaction system 10 facilitates digital asset-based interactions (e.g., a digital asset-based payment) between the source computing entity 12 and the destination computing entity 14. A digital asset-based interaction is any activity (e.g., a loan, a payment, etc.) involving the source computing entity 12 providing digital assets (e.g., digital assets 34) and the destination computing entity 14 accepting desired assets (e.g., fiat currency or a desired digital asset that differs from the digital assets the source computing entity 12 wishes to use in the digital asset-based interaction). Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights.

At the filing of this application, digital assets such as cryptocurrency are not widely accepted by merchants as a form of payment for a variety of reasons. For one, many merchants do not want to hold digital assets. Holding digital assets involves several issues merchants are unfamiliar with and/or unequipped to deal with. These issues include holding private key information, legal compliance, government regulation, timing issues such as waiting for transaction confirmations, etc. Accepting digital assets such as cryptocurrency presents operational security issues and includes a level of technical complexity outside the scope of general merchant capabilities. Additionally, the value of digital assets can be volatile, sometimes fluctuating dramatically in the course of one day. As another reason, merchants are reluctant to invest in expensive point-of-sale upgrades to accommodate digital asset payments directly. As yet another reason, many digital asset payments are public and expose sensitive merchant/customer information.

While some digital wallet applications enable retail blockchain payments, they are dependent on existing payment networks and thus are susceptible to the fraud attacks of the existing payment networks. For example, a digital asset is linked to a payment card (e.g., a credit card, debit card, gift card, etc.), where a digital asset payment is converted and conducted as a payment card transaction and, thus susceptible to the same fraud attacks as the payment card. Further, a billing address and/or other personal customer information may be required for a merchant to verify traditional payment card payments. A merchant may store this information which consumes data storage space and renders additional private customer information vulnerable to theft and fraud. Additionally, the costs of the existing payment network (e.g., payment transaction costs, fees, etc.) are maintained. Adding a digital asset payment option within an existing payment network only increases those costs.

Further, other digital wallet applications that enable retail blockchain payments may require that consumers store their digital assets with the entity that is facilitating the payment such that digital assets can be exchanged and sent to a merchant without the delay of confirming the digital assets sent by a consumer. Thus, the consumer gives up control of their digital assets in order to conduct payments in this manner. Further, when using existing digital asset-based payment systems, a consumer must use the digital wallet application associated with the entity that is facilitating the payment (e.g., the entity that storing digital assets on behalf of a consumer). The consumer therefore lacks the flexibility and freedom of spending from a digital wallet application of their choice.

Even though digital asset-based interactions such as cryptocurrency payments significantly reduce fraudulent activity as compared to traditional payments, fraudulent digital asset-based interactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a digital asset transaction from being authorized and completed correctly.

The digital asset-based interaction system 10 facilitates secure, fraud-less, real-time digital asset-based interactions (e.g., digital asset-based payments) between source computing entities wishing to use digital assets and destination computing entities wishing to receive desired assets where source computing entities can maintain control of their own digital assets and provide digital assets from a variety of digital asset wallet applications (e.g., asset management units) that are not associated with the digital asset-based interaction system 10 (e.g., associated with the digital asset-based interaction computing entity 16).

As used herein, a computing entity may be one or more computing devices, one or more distributed computing devices, and/or one or more modules executing on one or more computing devices. Within the digital asset-based interaction system 10, the source computing entity 12, the destination computing entity 14, the digital asset-based interaction computing entity 16, the digital asset backing computing entity 20, the one or more digital asset exchange computing entities 22, and the one or more staking computing entities 24 may be one or more computing devices, may be one or more distributed computing devices, and/or one or more modules executing on one or more computing devices.

As used herein, a computing device may be one or more portable computing devices and/or one or more fixed computing devices. The source computing entity 12, the destination computing entity 14, the digital asset-based interaction computing entity 16, the digital asset backing computing entity 20, the one or more digital asset exchange computing entities 22, and the one or more staking computing entities 24 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The source computing entity 12 includes an asset management unit 30 that stores digital assets 34. While only one asset management unit 30 is shown, the source computing entity 12 may include more than one asset management unit. In this example, the asset management unit 30 is storing one type of digital asset (e.g., digital assets 34) for simplicity, but in other embodiments, the source computing entity 12 may store a variety of types and/or amounts of digital assets.

The asset management unit 30 may be a digital wallet application installed on or otherwise usable by the source computing entity 12 that functions to facilitate the storage and management (e.g., buy, sell, trade, custody, etc.) of digital assets 34. The asset management unit 30 is operable to interact with the digital asset distributed ledger technology (DLT) networks (e.g., a blockchain) associated with the digital assets it stores and manages. The asset management unit 30 includes a combination of a public address and a private key.

In this example, the asset management unit 30 is a non-custodial digital wallet application that may be associated with a non-custodial digital asset management computing entity (e.g., a digital asset exchange company) where the asset management unit 30 stores digital assets and a user of the source computing entity 12 manages private keys to the asset management unit 30.

The asset management unit 30 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the asset management unit 30 is not associated with the digital asset-based interaction computing entity 16, but in other embodiments, the asset management unit 30 may be a custodial or non-custodial digital wallet application associated with the digital asset-based interaction computing entity 16 (e.g., via a source computing entity digital asset-based interaction interface). Alternatively, an asset management unit 30 may be a network enabled smart contract application. A network enabled smart contract application allows a user to upload digital assets to a network enabled smart contract using a private key (e.g., non-custodial) and eliminates double spending issues associated with non-custodial wallets.

The destination computing entity 14 may be associated with a particular merchant that facilitates payments from the source computing entity 12 to the merchant. For example, the destination computing entity 14 may be a fixed POS computing device, a merchant e-commerce website, a merchant mobile application (“app”), etc. The destination computing entity 14 may include payment features tailored to the type of destination computing entity 14 involved in a payment. For example, when the destination computing entity 14 is a fixed POS computing device (e.g., a register), the destination computing entity 14 includes features for an in-person payment interaction (e.g., a scanning device, a touchscreen, a receipt printer, etc.).

As another example, when the destination computing entity 14 is an e-commerce website or merchant mobile application (“app”), the destination computing entity 14 may include a variety of existing payment processing features (e.g., existing hardware and/or software) for processing online payments within existing payment networks (e.g., an Secure Socket Layers (SSL) certificate, e-commerce shopping cart software, order and product management features, customer profile management capabilities, a payment gateway, an e-commerce merchant account with a processing bank to accept credit and debit card payments, etc.).

The destination computing entity 14 includes a digital asset-based interaction interface 32 operable to interface with the digital asset-based interaction computing entity 16. For example, the digital asset-based interaction interface 32 is a digital asset-based interaction computing entity application programming interface (API) integrated into the destination computing entity 14 that allows the destination computing entity 14 to connect to the digital asset-based interaction computing entity 16 for digital asset-based interactions.

The destination computing entity 14 may include an asset management unit that does or does not include the digital asset-based interaction interface 32. When the destination computing entity 14 is associated with a merchant, its asset management unit may be an application that facilitates receiving assets during an interaction such as POS software and/or hardware that may or may not include a digital wallet function depending on the types of assets the destination computing entity 14 wishes to accept and/or the desired method of receiving those assets.

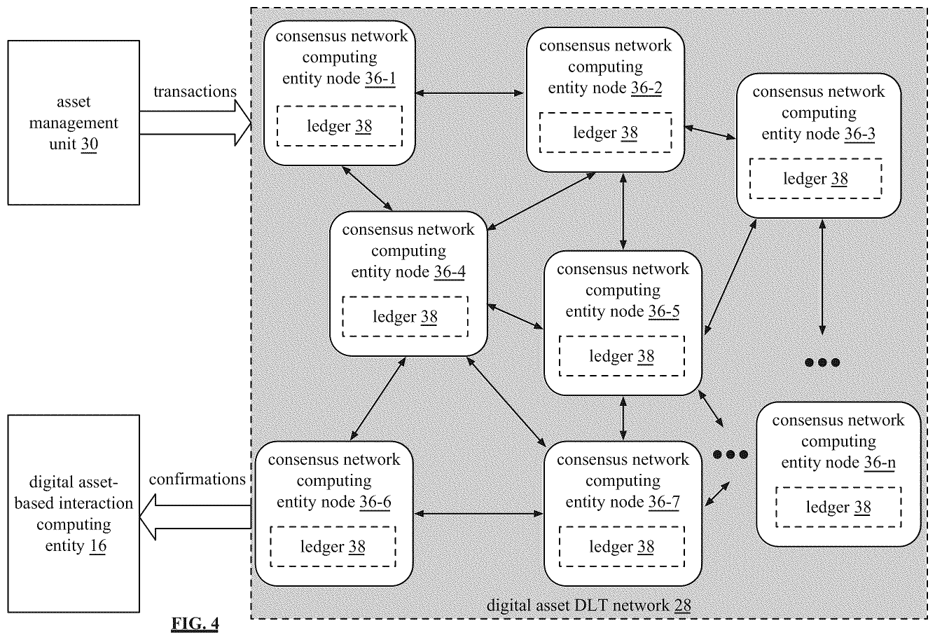

The digital asset DLT network 28 is a digital system associated with the digital assets 34 stored by asset management unit 30. A digital asset DLT network 28 includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes. The digital asset DLT network 28 and consensus network computing entity nodes will be discussed in more detail with reference to FIG. 4.

A digital asset DLT network 28 may be a multi-layer digital asset DLT network. A multi-layer digital asset DLT network is a digital system associated with a particular digital asset that includes an on-main ledger layer and one or more off-main ledger layers. For example, when an on-main ledger layer has a blockchain data structure, the additional layers to the on-main ledger layer (e.g., a main blockchain) may include one or more nested blockchains, state channels, and sidechains.

The one or more digital asset exchange computing entities 22 are online platforms that allow users to trade digital assets for other forms of digital assets or other assets such as conventional government-issued fiat currency and/or other digital currencies. The one or more digital asset exchange computing entities 22 may be associated with one or more trusted third parties to that may be specially licensed to facilitate exchanges when licensing is required. In an embodiment, the digital asset-based interaction computing entity 16 is a digital asset exchange computing entity where the digital asset exchange computing entity 16 may be specially licensed for exchange when licensing is required.

In another embodiment, the one or more digital asset exchange computing entities 22 may form a decentralized marketplace that does not involve a trusted third party and facilitates peer-to-peer exchanges. In another embodiment, the digital asset-based interaction computing entity 16 and/or the one or more digital asset exchange computing entities 22 may be associated with one or more digital asset holding companies. A digital asset holding company stores sensitive materials and has insurance policies to protect against theft and fraud. A digital asset holding company may be specially licensed for holding digital assets when licensing is required.

The digital asset backing computing entity 20 may be a part of or separate from the digital asset-based interaction computing entity 16. The digital asset backing computing entity 20 manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system 10.

The system digital assets may be any digital asset that the digital asset-based interaction system chooses to use for backing digital asset-based interactions. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account). The staking computing entities 24 provide the digital asset backing computing entity 20 with system digital assets and instructions on how to stake the system digital assets. For example, the staking computing entities 24 provide the digital asset backing computing entity 20 instructions to stake (i.e., back) the digital asset DLT network 28 with an amount of system digital assets.

Backing the digital asset DLT network 28 means that a particular consensus network computing entity node of the digital asset DLT network 28 is backed to ensure transactions are written onto the ledger. A consensus network computing entity node of the digital asset DLT network 28 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network 28 when initiating digital asset-based interactions. When a digital asset-based interaction involves digital assets stored in a custodial asset management unit, the custodial asset management unit is backed rather than a particular consensus network computing entity node of the digital asset DLT network because the custodian (e.g., a digital asset management computing entity) interacts with the digital asset DLT network on behalf of the source computing entity 12.

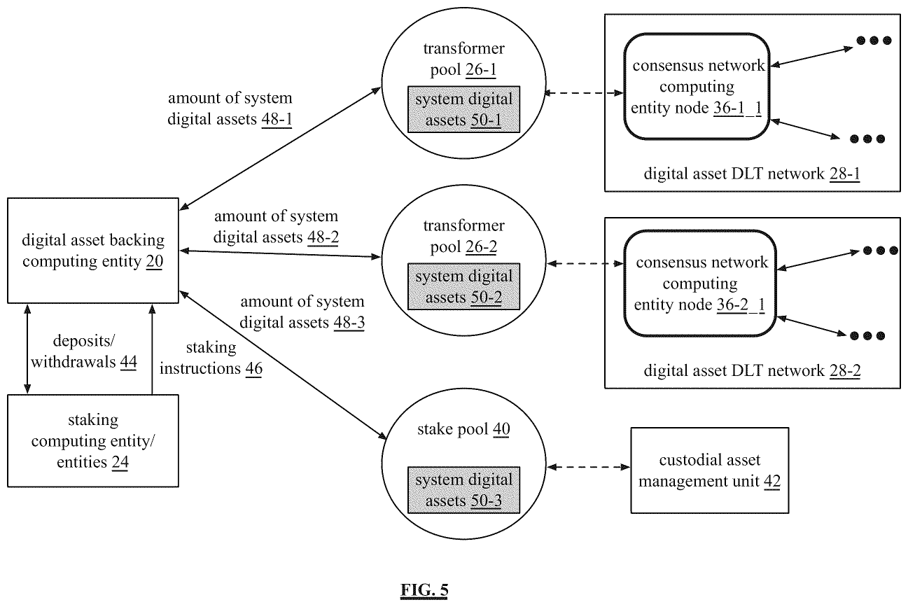

The transformer pool 26 is a smart contract (e.g., an Ethereum smart contract) that stores system digital assets to back digital asset-based interactions involving digital assets 34 stored in a non-custodial asset management unit 30 associated with the digital asset DLT network 28. When the one or more staking computing entities 24 (e.g., a user computing device, etc.) deposit system digital assets with the digital asset backing computing entity 20, the digital asset backing computing entity 20 keeps track of the deposits within the staking computing entity's account and is further operable to deposit an amount of the system digital assets into a particular transformer pool in accordance with system digital asset instructions (e.g., what digital asset DLT networks a staking computing entity wishes to back and for how much). The one or more staking computing entities 24, the digital asset backing computing entity 20, and the transformer pool 26 will be discussed in more detail with reference to FIG. 5.

Because the transformer pool 26 stores system digital assets to back digital asset-based interactions involving digital assets 34, the source computing entity 12 may use the digital assets 34 for digital asset-based interactions within the digital asset-based interaction system 10 regardless of asset management unit 30 used to store the digital assets 34. Thus, the source computing entity 12 has the freedom and flexibility to use the asset management unit 30 of its choosing while still benefiting from the secure and fast digital asset-based interaction processing of the digital asset-based interaction system 10.

The source computing entity 12 and the destination computing entity 14 interact via one or more interface means 18. For example, the source computing entity 12 and the destination computing entity 14 interact to initiate a digital asset-based interaction (may also be referred to herein as “interaction”). Initiation of a digital asset-based interaction will be discussed in further detail with reference to one or more of the subsequent Figures.

The interface means 18 includes one or more of: a direct link and a network connection. The direct link includes one or more of: a scanning device (e.g., video, camera, infrared (IR), barcode scanner, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the source computing entity 12 is a smart phone, the destination computing entity 14 is a fixed merchant POS computing device (e.g., a POS register) and the interface means 18 is the fixed merchant POS computing device's scanning device (e.g., camera, barcode scanner, etc.). As another example, the source computing entity 12 is a smart phone, the destination computing entity 14 is a fixed merchant POS device (e.g., a POS register) and the interface means 18 is the smart phone's scanning device (e.g., a front or back camera).

As another example, the source computing entity 12 is a smart phone, the destination computing entity 14 is an online POS connection device (e.g., an e-commerce website or e-commerce mobile app) and the interface means 18 is a network connection. For example, a smart phone uses an internet browser application (via cellular or wireless internet connection) to access a merchant's e-commerce website. As another example, a smart phone uses a network connection to connect to an installed merchant e-commerce mobile app.

As yet another example, a combination of interface means 18 is possible. For example, the source computing entity 12 is a smart phone and the destination computing entity 14 is an online POS connection device (e.g., an e-commerce website). The e-commerce website is accessed via a network connection interface means 18 on a computing device associated with the user of the source computing entity 12 (e.g., a laptop or desktop computer). The computing device displays information for use by the source computing entity's scanning device (e.g., front or back camera).

The digital asset-based interaction computing entity 16 is operable to facilitate digital asset-based interactions between the source computing entity 12 and the destination computing entities 14 by performing a real-time digital asset-based interaction process and a nonreal-time digital asset-based interaction process to reconcile the real-time digital asset-based interaction process with the digital asset backing computing entity 20. The digital asset-based interaction computing entity 16 is also operable to authorize digital asset-based interactions in accordance with system authorization parameters.

To perform the real-time digital asset-based interaction process, the digital asset-based interaction computing entity 16 is operable to connect to the one or more digital asset exchange computing entities 34 to convert digital assets to one or more desired assets (e.g., fiat currency, another digital asset, whatever asset format is desired by the destination computing entity 14) and send the desired assets to the destination computing entity 14. The real-time digital asset-based interaction process will be discussed in greater detail with reference to one or more subsequent Figures.

To perform the nonreal-time digital asset-based interaction process, the digital asset-based interaction computing entity 16 is operable to communicate with the digital asset backing computing entity 20 to back digital asset-based interactions such that they can be authorized and/or completed successfully in real-time and connect to the digital asset distributed ledger technology (DLT) network 28 associated with the digital assets to verify receipt of digital assets. The nonreal-time digital asset-based interaction process will be discussed in greater detail with reference to one or more subsequent Figures.

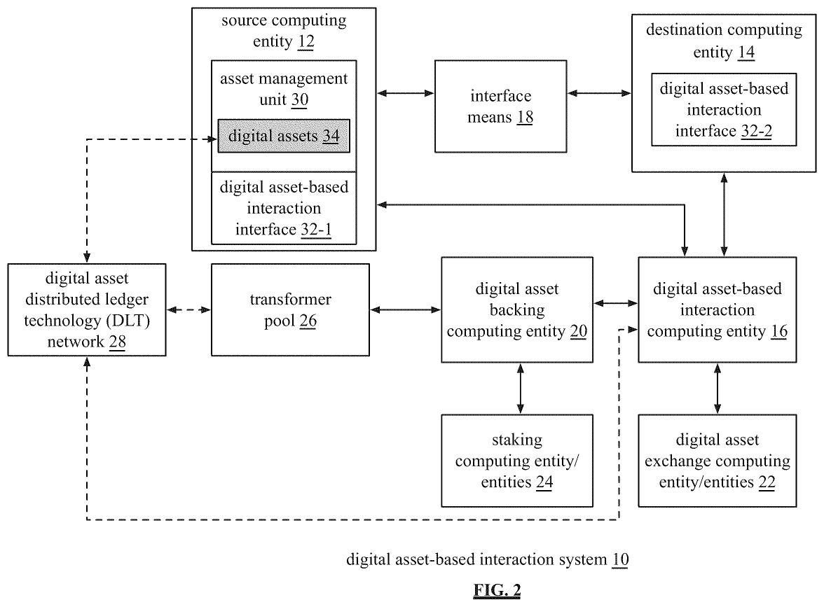

FIG. 2 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a transformer pool 26, and a digital asset distributed ledger technology (DLT) network 28.

The digital asset-based interaction system 10 of FIG. 2 operates similarly to the digital asset-based interaction system 10 of FIG. 1 except that the asset management unit 30 of the source computing entity 12 includes a digital asset-based interaction interface 32-1 that is associated with the digital asset-based interaction computing entity 16. Even though the source computing entity 12 is not obligated to use an asset management unit 30 associated with the digital asset-based interaction computing entity 16 to conduct digital asset-based interactions with the digital assets 34, the source computing entity 12 could choose to use the asset management unit 30 associated with the digital asset-based interaction computing entity 16 (e.g., with the digital asset-based interaction interface 32-1) for a plurality of other features.

For example, by using the asset management unit 30 with the digital asset-based interaction interface 32-1, the source computing entity 12 is operable to obtain scannable codes from the digital asset-based interaction computing entity 16 to initiate digital asset-based interactions with the destination computing entity 14.

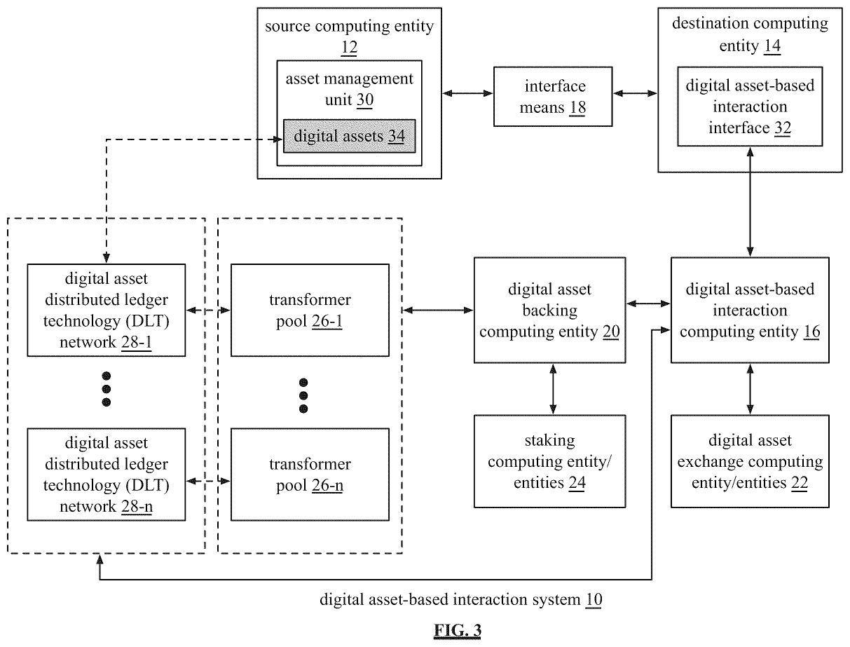

FIG. 3 is schematic block diagram of another embodiment of a digital asset-based interaction system 10 that includes a source computing entity 12, a destination computing entity 14, an interface means 18, a digital asset-based interaction computing entity 16, a digital asset backing computing entity 20, one or more digital asset exchange computing entities 22, one or more staking computing entities 24, a plurality of transformer pools 26-1 through 26-n, and a plurality of digital asset distributed ledger technology (DLT) networks 28-1 through 28-n.

The digital asset-based interaction system 10 of FIG. 3 operates similarly to the digital asset-based interaction system of FIG. 1 except that the digital asset-based interaction system 10 of FIG. 3 includes a plurality of transformer pools 26-1 through 26-n and a plurality of digital asset DLT networks 28-1 through 28-n. For example, a first digital asset DLT network 28-1 is associated with the digital assets 34 and a first transformer pool 26-1 stores system digital assets to back digital asset-based interactions associated with the digital assets 34. As another example, a second digital asset DLT network 28-2 is associated with second digital assets and a second transformer pool 26-2 stores system digital assets to back digital asset-based interactions associated with the second digital assets. As another example, a third digital asset DLT network 28-3 is associated with third digital assets and a third transformer pool 26-3 stores system digital assets to back digital asset-based interactions associated with the third digital assets.

FIG. 4 is a schematic block diagram of an embodiment of a portion of the digital asset-based interaction system that includes an asset management unit 30 (e.g., of the source computing entity), a digital asset-based interaction computing entity 16, and a digital asset distributed ledger technology (DLT) network 28.

The digital asset DLT network 28 includes a plurality of consensus network computing entity nodes 36-1 through 36-n (also referred to herein as nodes) that each store a distributed and replicated ledger 38 and use validation procedures (e.g., consensus methods) to ensure replication across the plurality of consensus network computing entity nodes 36-1 through 36-n is undertaken. Distributed ledgers 38 may be permissioned, permissionless, or hybrid. Consensus methods include proof of work, proof of stake, delegated proof of stake, Byzantine Fault Tolerance, voting systems, etc.

When a user such as the asset management unit 30 submits a new transaction, it is received by a consensus network computing entity node of the plurality of consensus network computing entity nodes 36-1 through 36-n and the consensus network entity node broadcasts the transaction to the rest of the network. When a new transaction on the ledger 38 occurs, each of the consensus network computing entity nodes 36-1 through 36-n construct the new transaction and vote by a consensus method on which copy of the ledger 28 is correct. Once consensus is determined, all consensus network computing entity nodes 36-1 through 36-n update the ledger 38 with the correct copy. Blockchain is a form of digital asset DLT network that uses cryptographic and algorithmic approaches to create and verify a continuously expanding, append-only data structure that gradually turns into a chain of transaction blocks that serve the role of the ledger 38.

In the Bitcoin blockchain, nodes validate transactions and specialized nodes known as miners (or a collective of miners) pick up the transactions and compete to confirm pending transactions. Going from pending to confirmed means that the transaction has been added to the ledger (blockchain). Bitcoin miners batch pending transactions into what are known as blocks. The confirmed block is propagated across the entire network back to all nodes. Once validated, the nodes add the block to the previous block thus creating a blockchain. Some blockchain networks do not require mining such as blockchains that use proof of stake consensus methods where participants must have a stake in the blockchain to select, verify, and validate transactions.

Non-blockchain forms of digital asset DLT networks store transactions in data architectures that differ from blockchains. For example, a hashgraph data structure stores all transactions in a parallel structure. Hashgraphs do not use miners to validate transactions and instead use a “gossip about gossip” consensus method where individual nodes on the network “gossip” about transactions to create directed acyclic graphs that time-sequence transactions without bundling them into blocks.

In this example, the asset management unit 30 is adding one or more transactions (e.g., a digital asset-based interaction may include one or more transactions) to the digital asset DLT network 28. For example, a digital asset-based interaction involving a digital asset associated with the digital asset DLT network 28 is added as a transaction on the ledger 38. To add the transaction on the ledger 38, a particular consensus network computing entity node receives the transaction and broadcasts it to the other consensus network computing entity nodes on the digital asset DLT network 28. The on-ledger transaction includes information related to the asset management unit 30 sending an amount of the digital assets to the digital asset-based interaction computing entity 16. To ensure that the transaction is added to the ledger, the consensus network computing entity node receiving the transaction is backed with system digital assets (e.g., the digital asset DLT network 28 is backed).

The digital asset-based interaction computing entity 16 communicates with the digital asset DLT network 28 to obtain a desired amount of confirmations regarding the digital asset-based interaction transaction added via the asset management unit 30. Based on the type of digital asset DLT network 28 and the validation procedures used by the digital asset DLT network 28, the desired amount of confirmations may take minutes to hours of time to obtain.

FIG. 5 is a schematic block diagram of an embodiment of a portion of a digital asset-based interaction system 10 that includes a digital asset backing computing entity 20, one or more staking computing entities 24, transformer pool 26-1 through 26-2, stake pool 40, digital asset distributed ledger technology (DLT) networks 28-1 through 28-2, and a custodial digital asset management unit 42.

The digital asset backing computing entity 20 manages the storage and use of system digital assets (e.g., system cryptocurrency, system tokens, etc.) for collaterally backing digital asset-based interactions and may be a part of or separate from the digital asset-based interaction computing entity 16. The digital asset backing computing entity 20 interacts with the one or more staking computing entities 24. The one or more staking computing entities 24 provide the digital asset backing computing entity 20 with system digital assets (deposits/withdrawals 44) and instructions on how to stake the system digital assets (staking instructions 46).

The one or more staking computing entities 24 may be one or more user computing devices, one or more merchant computing entities, a digital asset management computing entity associated with an asset management unit, one or more computing entities associated with a corporation and/or business, etc. The one or more staking computing entities 24 (e.g., a user computing device, etc.) are associated with the digital asset backing computing entity 20 via an account (e.g., a stake account).

System digital assets are digital assets that serve as collateral to back digital asset-based interactions of the digital asset-based interaction system. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency. The digital asset backing computing entity 20 also manages information associated with the one or more staking computing entities 24 such as identifying information of the one or more staking computing entities 24, system digital asset balances and availability, rewards calculations, etc.

The digital asset DLT networks 28-1 through 28-2 are digital systems associated with a particular digital asset. A digital asset DLT network includes a plurality of consensus network computing entity nodes operable to implement a validation procedure to verify the authenticity of transactions recorded on a distributed ledger. For example, the validation procedure is a consensus method. Examples of consensus methods include proof-of-work, proof-of-stake, Practical Byzantine Fault Tolerance (PBFT), and Directed Acyclic Graph (DAG). The plurality of consensus computing entity nodes executes the validation procedure to validate and broadcast transactions to the distributed ledger stored by each consensus network computing entity node of the plurality of consensus network computing entity nodes.

For example, the DLT network 28-1 may be the Ethereum network and the particular digital asset it is associated with is Ether. As another example, the DLT network 28-2 may be the Bitcoin network and the particular digital asset it is associated with is Bitcoin.

The custodial asset management unit 42 may be a custodial digital wallet application associated with a digital asset management computing entity that may be specially licensed and insured to hold digital assets (e.g., a digital asset holding and management company, a cryptocurrency holding company, a cryptocurrency holding and exchange company, etc.). The digital asset management computing entity (i.e., “the custodian”) of a custodial digital wallet application holds the private key needed to gain access to digital assets.

In this example, the one or more the staking computing entities 24 provide the digital asset backing computing entity 20 with system digital assets (e.g., deposits/withdrawals 44) and staking instructions 46. The staking instructions 46 include instructions to stake an amount of system digital assets 48-1 to back the digital asset DLT network 28-1 (e.g., the Ethereum network), instructions to stake an amount of system digital assets 48-2 to back the digital asset DLT network 28-2 (e.g., the Bitcoin network), and instructions to stake an amount of system digital assets 48-3 to back a custodial asset management unit 42. The digital asset backing computing entity 20 keeps track of the amounts of system digital assets each staking computing entity 24 of the one or more staking computing entities 24 is contributing/depositing via each staking computing entity's account.

Backing the digital asset DLT networks 28-1 and 28-2 means that a consensus network computing entity node 36-1_1 of the digital asset DLT network 28-1 is backed to ensure transactions are written onto the ledger and a consensus network computing entity node 36-2_1 of the digital asset DLT network 28-2 is backed to ensure transactions are written onto the ledger. The consensus network computing entity nodes 36-1_1 and 36-2_1 may be associated with the digital asset-based interaction computing entity 16. Backing a particular consensus network computing entity node of the digital asset DLT network 28 is necessary for backing digital asset-based interactions involving digital assets stored in a non-custodial asset management unit not associated with the digital asset-based interaction computing entity 16 because the non-custodial asset management unit is interfacing directly with the digital asset DLT network when initiating digital asset-based interactions. When a digital asset-based interaction involves digital assets stored in a custodial asset management unit, the custodial asset management unit (such as custodial asset management unit 42) is backed rather than a particular consensus network computing entity node of the digital asset DLT network because the custodian (e.g., a digital asset management computing entity) interacts with the digital asset DLT network on behalf of the custodial asset management unit.

Based on the staking instructions 46, the digital asset backing computing entity 20 deposits the amount of the system digital assets 48-1 into transformer pool 26-1 where transformer pool 26-1 is associated with the consensus network computing entity node 36-1_1 of the digital asset DLT network 28-1, deposits the amount of the system digital assets 48-2 into transformer pool 26-2 where transformer pool 26-2 is associated with the consensus network computing entity node 36-2_1 of the digital asset DLT network 28-2, and deposits the amount of the system digital assets 48-3 into the stake pool 40 where the stake pool 40 is associated with the custodial asset management unit 42.

The transformer pools 26-1 through 26-2 and the stake pool 40 are smart contracts (e.g., Ethereum smart contracts) that store system digital assets to back digital asset DLT networks 28-1 through 28-2 and the custodial asset management unit 42. For example, the transformer pool 26-1 stores system digital assets 50-1 for backing digital asset DLT network 28-1 digital asset-based interactions (e.g., digital asset-based interactions involving Ether when the digital asset DLT network 28-1 is the Ethereum network), the transformer pool 26-2 stores system digital assets 50-2 for backing digital asset DLT network 28-2 digital asset-based interactions (e.g., digital asset-based interactions involving Bitcoin when the digital asset DLT network 28-2 is the Bitcoin network), and the stake pool 40 stores system digital assets 50-3 for custodial asset management unit 42 digital asset-based interactions.

With digital asset DLT networks backed by system digital assets, users (e.g., source computing entities) can provide digital assets associated with those backed digital asset DLT networks for digital asset-based interactions from any digital wallet application (e.g., asset management unit) of their choosing. In other words, a user does not need to be associated with the digital asset-based interaction system (e.g., use an asset management unit that is staked and therefore associated with the digital asset-based interaction computing entity) to partake in digital asset-based interactions facilitated by the digital asset-based interaction system.

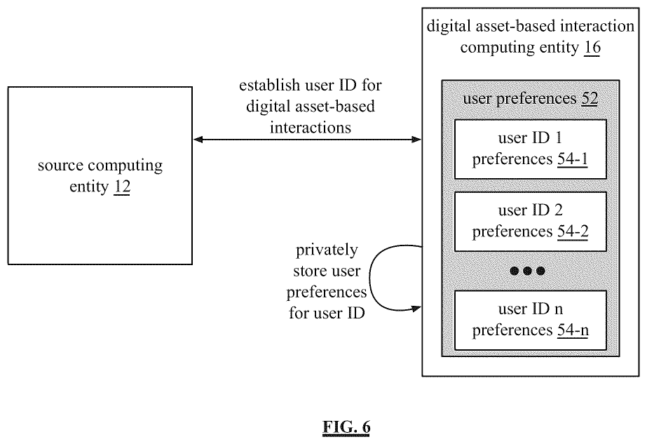

FIG. 6 is a schematic block diagram of a source computing entity 12 and a digital asset-based interaction computing entity 16 of a digital asset-based interaction system. Either through the digital asset-based interaction interface (as discussed with reference to FIG. 2), or when initiating a digital asset-based interaction with a destination computing entity, the source computing entity establishes a user identifier (ID) associated with a user of the source computing entity with the digital asset-based interaction computing entity 16 to use for digital asset-based interactions. The user ID may be a unique code, an email address, a username and password, etc.

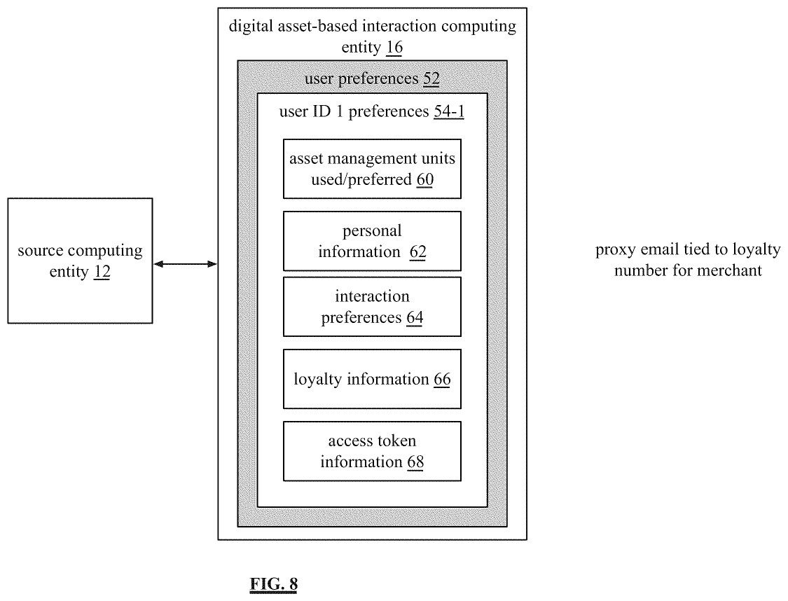

The digital asset-based interaction computing entity 16 is operable to determine user preferences 52 of various source computing entities based on past digital asset-based interactions, a query, user input, etc. The digital asset-based interaction computing entity 16 is then operable to privately store the user preferences and apply the preferences towards future digital asset-based interactions without sharing the information directly with a destination computing entity (e.g., a merchant). In this example, the digital asset-based interaction computing entity 16 stores user preferences associated with user IDs 1-n (user ID 1 preferences 54-1 through user ID n preferences 54-n). User preferences may include personal information such as an email address and shipping address, wallets (e.g., asset management units) the user has/uses, digital asset-based interaction preferences, loyalty information, interaction token information, etc. In this example, the source computing entity 12 may be associated with user ID 1. The user preferences will be discussed in more detail with reference to FIG. 8.

By privately storing and managing source computing entity 12 information linked to a user ID, the digital asset-based interaction computing entity 16 can fractionalize the data involved in a digital asset-based interaction (e.g., private user information is not carried through with the digital asset-based interaction, shared with other parties, and/or published on a blockchain). This allows the source computing entity 12 to have control over what personal information is shared.

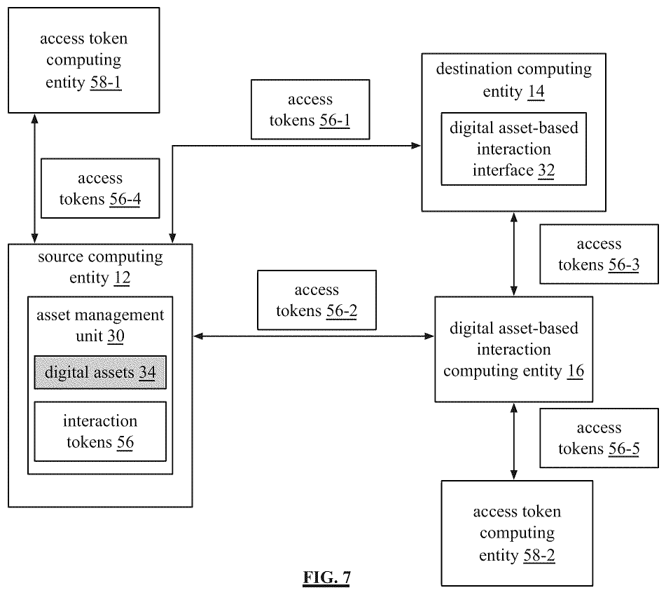

FIG. 7 is a schematic block diagram of an embodiment of exchanging access tokens 56 between one or more computing entities of the digital asset-based interaction system. An access token 56 is token granting access to a something of value. The something of value may be a product to purchase, a free product, a discount, a community, an event, an experience, etc. The access tokens 56 may be a non-fungible token (NFT) assigned with unique identification code(s) and metadata to distinguish them from other tokens. In this example, the source computing entity 12 may obtain access tokens 56-1 from a destination computing entity 14 (via an interface means) before, during, or after a digital asset-based interaction. In another example, the source computing entity 12 may obtain access tokens 56-4 from an access token computing entity 58-1. An access token computing entity 58-1 and 58-2 is a computing entity that generates and issues access tokens on behalf of destination computing entities (e.g., merchants), third-party computing entities associated with destination computing entities, asset management units, etc.

In another example, the digital asset-based interaction computing entity 16 may obtain access tokens 56-3 from a destination computing entity 14 in connection with a digital asset-based interaction and provide the access tokens 56-3 to source computing entity 12 or store them on the source computing entity's 12 behalf. In another example, the digital asset-based interaction computing entity 16 may generate access tokens 56-4 and provide the access tokens 56-4 to the source computing entity 12 or store them on the source computing entity's 12 behalf. In another example, the digital asset-based interaction computing entity 16 may obtain access tokens 56-5 from an access token computing entity 58-2 and provide the access tokens 56-5 to the source computing entity 12 or store them on the source computing entity's 12 behalf.

FIG. 8 is a schematic block diagram of an embodiment of a digital asset-based interaction computing entity 16 and a source computing entity 12 of the digital asset-based interaction system. The digital asset-based interaction computing entity 16 stores user preferences 52. The source computing entity 12 is associated with a user ID 1 as discussed with reference to FIG. 6. As an example, the user ID 1 preferences 54-1 include asset management units used/preferred 60, personal information 62, interaction preferences 64, loyalty information 66, and access token information 68.

The asset management units used/preferred 60 is a list of asset management units the source computing entity 12 has used in the past to complete digital asset-based interactions, one or more default asset management units selected by the source computing entity 12, one or more preferred asset management units, etc. The asset management units listed may be associated with conditions (e.g., use asset management unit 1 for digital asset-based interactions with destination computing entity 1, use asset management unit 2 for digital asset-based interactions involving digital asset 1, etc.). The personal information 62 may include email address, shipping address, general user location, favorite merchants, etc. The interaction preferences 64 may include tipping preferences, shipping speed preferences, merchant specific preferences (e.g., at merchant 1, use digital asset 1), spending preferences (e.g., if purchase is over X amount, use half digital asset 1 and half digital asset 2), etc. Loyalty information 66 may include loyalty points collected from past digital asset-based interactions with destination computing entities and information related to loyalty accounts with destination computing entities.

For example, the digital asset-based interaction computing entity 16 may assign a proxy email or username for the source computing entity 12 to establish a loyalty account with a destination computing entity. The proxy email is stored in the loyalty information 66 and is connected to the source computing entity such that the user of the source computing entity 12 can participate in loyalty programs without sharing their real email address while destination computing entities can distinguish between new and existing loyalty program members.

The access token information 68 includes access tokens that the digital asset-based interaction computing entity 16 has obtained and/or generated and provided to the source computing entity 12 (e.g., stored in a source computing entity's 12 asset management unit, or stored digital asset-based interaction computing entity 16 in the source computing entity's 12 preferences) to apply to future digital asset-based interactions. The digital asset-based interaction computing entity 16 may alert the source computing entity 12 of promotions or discounts related to access tokens available to the source computing entity 12.

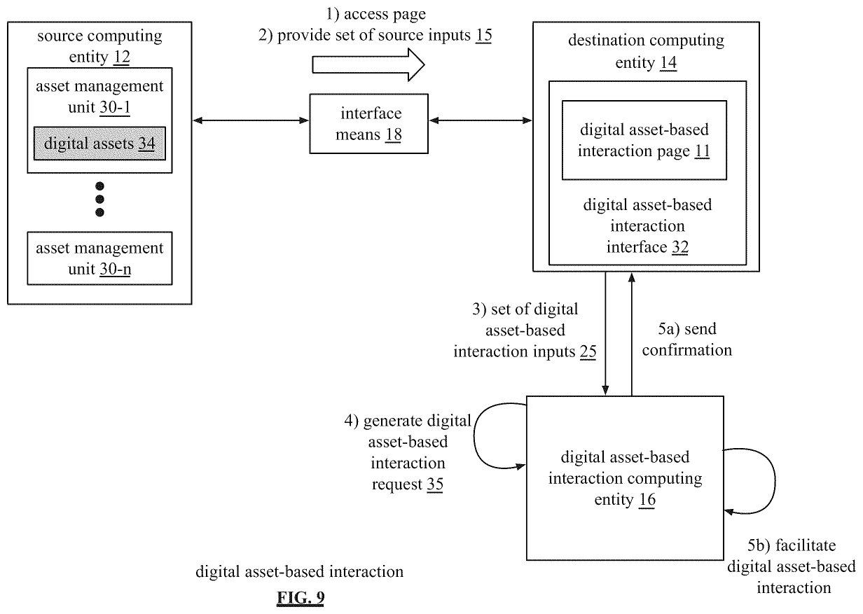

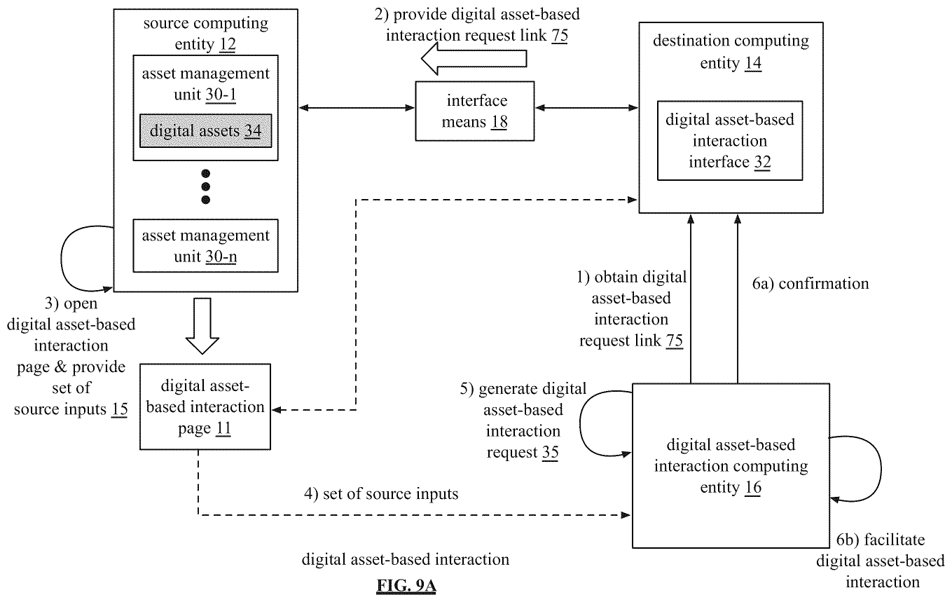

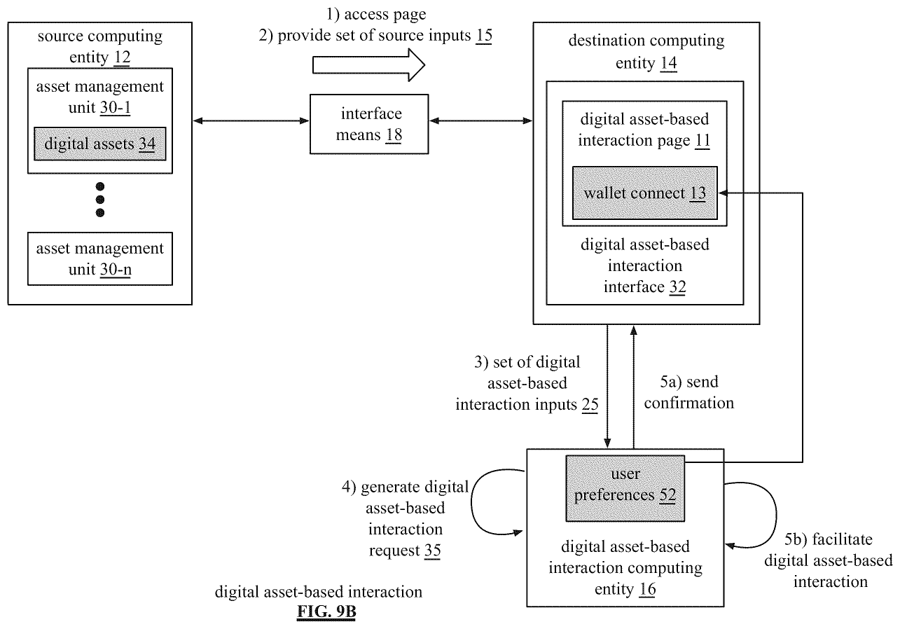

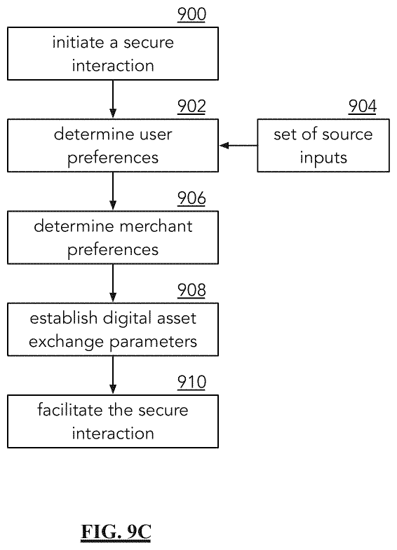

FIG. 9 is a flowchart of an example of a method of facilitating a digital asset-based interaction via a digital asset-based interaction page 11. FIG. 9 depicts a portion of a digital asset-based interaction system that includes a source computing entity 12, a destination computing entity 14, an interface means 18, and a digital asset-based interaction computing entity 16.

The source computing entity 12 includes a plurality of asset management units 30-1 through 30-n. An asset management unit 30-1 stores digital assets 34. In this example, the asset management unit 30-1 is not associated with the digital asset-based interaction computing entity 16. The method begins with step 1 where a source computing entity 12 accesses a digital asset-based interaction page 11 to initiate a digital asset-based interaction with a destination computing entity 14. The digital asset-based interaction involves the source computing entity 12 providing digital assets 34 and the destination computing entity 14 accepting desired assets. In this example, the source computing entity 12 connects to the destination computing entity 14 via an interface means 18 to access the digital asset-based interaction page 11. For example, the digital asset-based interaction page 11 is integrated in the API of the destination computing entity 11 and is an aspect of the digital asset-based interaction interface 32 that connects to the digital asset-based interaction computing entity 16.

In another example, the source computing entity 12 connects to the destination computing entity 14 via a destination computing entity application installed on the source computing entity 12 (e.g., a network interface means) to access the digital asset-based interaction page 11. As another example, the source computing entity 12 connects to the destination computing entity 14 via a browser application installed on the source computing entity 12 (e.g., a network interface means) to access a webpage associated with the destination computing entity 14 to access the digital asset-based interaction page 11.

The method continues with step 2 where the source computing entity 12 inputs a set of source inputs 15 via the digital asset-based interaction page 11. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method continues with step 3 where the digital asset-based interaction computing entity obtains a set of digital asset-based interaction inputs 25 from the digital asset-based interaction page 11. The set of digital asset-based interaction inputs 25 includes at least some of the set of source inputs and optionally destination computing entity information when necessary (e.g., an amount of the digital asset-based interaction, desired assets, etc.). Based on the set of source inputs, the digital asset-based interaction computing entity 16 is operable to identify user preferences based on a user ID (e.g., the source ID) and the apply the preferences to the digital asset-based interaction. The source computing entity 12 is also operable to open a conversation with the destination computing entity 14 via the interface means 18 to communicate preferences (e.g., no receipt, email receipt, etc.).

The method continues with step 4 where the digital asset-based interaction computing entity 16 generates a digital asset-based interaction request 35 based on the set of digital asset-based interaction inputs 25. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 5a and 5b which may occur concurrently or slightly before or after one another (e.g., step 5b occurs slightly before step 5a). At step 5a, the digital asset-based interaction computing entity 16 sends the destination computing entity 14 a confirmation that the digital asset-based interaction is successful. At step 5b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

As an alternative, prior to generating the digital asset-based interaction request at step 4, the digital asset-based interaction computing entity sends user preferences to the destination computing entity 14 to display to the user (if allowed by user preferences) such as asset management unit balances (e.g., wallet connect). The user can then complete the source input selection based on this information and the method continues with step 3.

FIG. 9A is a flowchart of an example of a method of facilitating a digital asset-based interaction via a digital asset-based interaction page 11. FIG. 9A depicts a portion of a digital asset-based interaction system that includes a source computing entity 12, a destination computing entity 14, an interface means 18, and a digital asset-based interaction computing entity 16.

The source computing entity 12 includes a plurality of asset management units 30-1 through 30-n. An asset management unit 30-1 stores digital assets 34. In this example, the asset management unit 30-1 is not associated with the digital asset-based interaction computing entity 16. The method begins with step 1 where the destination computing entity 14 obtains a digital asset-based interaction request link 75 from the digital asset-based interaction computing entity 16 for use in a digital asset-based interaction. The digital asset-based interaction request link 75 may be a quick response (QR) code, another type of scannable code, a uniform resource locator (URL) link, a button (e.g., a hypertext markup language (HTML) button, or any type of mechanism for directing the source computing entity to a digital asset-based interaction page 11. The digital asset-based interaction request link 75 may be a repeatable link that can be repeatedly used for separate sources but related destination digital asset-based interactions (e.g., a donation link to a particular cause). For example, a repeatable link could allow a route to a new instance of the digital asset-based interaction page 11 each time it is accessed.

The destination computing entity 14 may provide destination computing entity information and/or digital asset-based interaction information to the digital asset-based interaction computing entity 16 such that the digital asset-based interaction computing entity 16 provides a link specific to the digital asset-based interaction. In another embodiment, the destination computing entity 14 may be operable to generate the digital asset-based interaction request link 75. The method continues with step 2 where the destination computing entity 14 provides the digital asset-based interaction request link 75 to the source computing entity 12 via an interface means 18.

The method continues with step 3 where the source computing entity 12 accesses a digital asset-based interaction page 11 through the digital asset-based interaction request link 75 (e.g., a website via a browser application or a destination computing entity mobile application opens to a digital asset-based interaction page 11 when the link is used) to initiate a digital asset-based interaction with the destination computing entity 14. For example, when the destination computing entity 14 is point-of-sale (POS) register and the digital asset-based interaction request link 75 is a scannable code, a display of the destination computing entity 14 displays the digital asset-based interaction request link 75 where a scanning device interface means of the source computing entity 12 is operable to scan the digital asset-based interaction request link 75. As another example, when the destination computing entity 14 is a mobile application installed on the source computing entity 12 and the interface means 18 is a network connection, the digital asset-based interaction request link 75 is provided to the source computing entity 12 via the network connection.

The method continues with step 4 where the source computing entity 12 inputs a set of source inputs 15 via the digital asset-based interaction page 11 which are sent to the digital asset-based interaction computing entity 16. The set of source inputs may include a source identifier (e.g., a source ID, an email address, etc.), an intent to initiate the digital asset-based interaction (e.g., a confirmation, scanning of a code, etc.), a digital asset type (e.g., Bitcoin, Ether, etc.), a digital asset source (e.g., a network, a particular digital wallet), an amount of the digital asset-based interaction, and other source computing entity information (e.g., a customer loyalty number, shipping information, etc.) or digital asset-based interaction information (e.g., items involved, etc.).

The method may optionally include the digital asset-based interaction computing entity obtaining destination information (e.g., an amount of the digital asset-based interaction, type of desired assets, etc.) from the destination computing entity 14 via the digital asset-based interaction interface 32. In another embodiment, the destination information and/or any other digital asset-based interaction information is contained within the digital asset-based interaction request link 75 such that the source computing entity 12 is operable to view the destination information and/or any other digital asset-based interaction information on the digital asset-based interaction page 11.

The method continues with step 5 where the digital asset-based interaction computing entity 16 generates a digital asset-based interaction request 35 based on the set of source inputs and the destination information. The digital asset-based interaction request 35 is a set of digital asset-based interaction instructions for a particular network. For example, when the set of source inputs identifies Bitcoin as the type of digital asset and Coinbase as the digital asset source (e.g., a particular asset management unit), the digital asset-based interaction computing entity 16 generates a digital asset-based interaction request 35 with instructions on pulling the required amount of Bitcoin from the source computing entity's Coinbase address.

The method continues with steps 6a and 6b which may occur concurrently or slightly before or after one another (e.g., step 6b occurs slightly before step 6a). At step 6a, the digital asset-based interaction computing entity 16 sends the destination computing entity 14 a confirmation that the digital asset-based interaction is successful. At step 6b, the digital asset-based interaction computing entity 16 facilitates the digital asset-based interaction based on the digital asset-based interaction request using a real-time digital asset-based interaction process and a nonreal-time digital asset-based interaction process. The real-time digital asset-based interaction process and a nonreal-time digital asset-based interaction process will be described in greater detail with reference to one or more of the subsequent Figures.

FIG. 9B is a flowchart of an example of a method of facilitating a digital asset-based interaction via a digital asset-based interaction page 11 with wallet connect 13 functionality. FIG. 9B depicts a portion of a digital asset-based interaction system that includes a source computing entity 12, a destination computing entity 14, an interface means 18, and a digital asset-based interaction computing entity 16.

FIG. 9B operates similarly to the example of FIG. 9 except that user preferences 52 stored by the digital asset-based interaction computing entity 16 can be used in establishing a wallet connect function on a digital asset-based interaction page 11. Using the wallet memory of a user (e.g., the asset management units that the user of the source computing entity uses), a wallet connect extension to the digital asset-based interaction page 11 which would allow a user to view wallet balances and complete the digital asset-based interaction through its desired wallet (e.g., asset management unit).

FIG. 9C is a logic diagram of an example of a method for a secure interaction that begins at step 900 where a source computing entity or by a destination computing entity initiates a secure interaction between them. For instance, the source computing entity initiates the secure interaction with the destination computing entity or the destination computing entity initiates the secure interaction with the source computing entity. The secure interaction is regarding something of value, which, for example, is a product to purchase, a free product, a discount, a community, an event, an experience, etc.

In one example, the source computing entity initiates the secure interaction by accessing a digital asset-based interaction page 11 as shown in FIGS. 9 and 9B. In another example, the destination computing entity initiates the secure interaction by providing a digital asset-based interaction request link to the source computing entity as shown in FIG. 9A.

The initiation of the secure interaction further includes informing an interaction computing entity of the initiated secure transaction by the source computing entity or by the destination computing entity. For example, the destination computing entity sends a set of digital asset-based interaction inputs to the interaction computing entity. The set of digital asset-based interaction inputs include digital information regarding the merchant preferences.

The merchant preferences includes one or more of (1) a preferred type of interaction (e.g., sale of items, lease of items, trade of items, consignment of items, storage of items, etc.); (2) a preferred digital asset payment type for different types of interactions (e.g., fiat currency, a digital representation thereof, a specific type of cryptocurrency, a different digital asset a digital image, a digital audio file, a digital video file, digitized documents (e.g., contracts, legal documents, etc.), cryptocurrency tokens, digital fiat currency, stocks, and intellectual property rights)); (3) a preferred authentical mechanism (e.g., use of a token, private/public key pair, etc.); (4) special offers for selected things of value (e.g., special pricing on select items, flash sales, time of day sales, etc.); and (5) special offers for selected users via their associated source computing entities (e.g., preferred customer offers, loyalty points, etc.).

As another example, the source computing entity sends the set of source inputs to the interaction computing entity as a way of informing the interaction computing entity. The set of source inputs includes digital information regarding the source computing entity and/or digital information regarding the secure interaction. The digital information regarding the source computing entity includes one or more of:
a user identifier associated with the source computing entity;
a source computing entity identifier;
a user email address associated with the source computing entity;
a user physical address associated with the source computing entity;
a list of digital assets associated with a user via the source computing entity;
a source computing entity IP address;
access token information;
a user telephone number associated with the source computing entity; and
a customer loyalty number associated with the source computing entity or with the user identifier.

The digital information regarding the secure interaction includes one or more of:
intent to initiate the secure interaction via:
   sending a digital communication regarding initiating the secure interaction, or
   scanning a code regarding the secure interaction;
identity of a digital asset source; and
an offer for sale amount regarding the something of value; and
identity of the something of value.

The method continues at step 902 where the interaction computing entity determines user preferences associated with the source computing entity based on a set of source inputs (via step 904) associated with the source computing entity. In an embodiment, the user preferences include identify of a cryptocurrency digital asset for which the source computing entity is offering to pay for the something of value. In another embodiment, the user preferences include one or more selected elements of the digital information regarding the source computing entity.

In an example, the interaction computing entity interprets a smart contract associated with the source computing entity. The smart contract includes a plurality of purchasing preferences of a user associated with the source computing device, which are based on the user preferences.

The method continues at step 906 where the interaction computing entity determines merchant preferences associated with the destination computing entity. The merchant preferences include a preferred digital asset payment type and/or other merchant preferences as discussed above. In an example, the interaction computing entity interprets a smart contract associated with the destination computing entity. The smart contract includes a plurality of preferences of a merchant associated with the destination computing device (i.e., the merchant preferences).

The method continues at step 908 where the interaction computing entity establishes digital asset exchange parameters for the secure interaction based on the user preferences and on the merchant preferences. The digital asset exchange parameters include one or more of:
proxy information regarding the user preferences of a user associated with the source computing entity;
sufficient staking of the cryptocurrency digital asset of the source computing entity for purchasing of the something of value;
a sales price for purchase of the something of value via the source computing entity by the associated user;
applicable customer loyalty benefits of the associated user regarding the purchasing of the something of value and/or purchasing via the destination computing entity associated with a merchant; and
an access token to ensure integrity of the secure interaction.

The method continues at step 910 where the interaction computing entity facilitates the secure interaction between the source computing entity and the destination computing entity based on the digital asset exchange parameters when the digital asset exchange parameters were confirmed by the source computing entity and/or the destination computing entity. In an example, the source computing entity and/or the destination computing entity confirms the digital asset exchange parameters by providing a confirmation response to a confirmation query from the interaction computing entity. As another example, the digital asset exchange parameters are confirmed via an access token.

The facilitating of the secure interaction further includes, when sufficient staking of the cryptocurrency digital asset for the sales price for purchase of the something of value has been verified, the interaction computing entity determines applicable customer loyalty benefits. This sub-method includes the interaction computing entity applying the applicable customer loyalty benefits to purchase of the something of value. The sub-method further includes the interaction computing entity executing the secure interaction using the proxy information regarding the associated user and/or of the source computing entity.

FIG. 10 is a flowchart of an example of a method of a digital asset-based interaction computing entity 16 facilitating a digital asset-based interaction between a source computing entity and a destination computing entity. FIG. 10 depicts a portion of a digital asset-based interaction system that includes a destination computing entity 14, a digital asset-based interaction computing entity 16, one or more digital asset exchange computing entities 22, a digital asset distributed ledger (DLT) network 28, and a digital asset backing computing entity 20.

FIG. 10 continues the examples of previous Figures when the digital asset-based interaction computing entity 16 facilitates the digital asset-based interaction by executing steps 1a and 1b. Steps 1a and 1b may occur simultaneously or at slightly different times (e.g., step 1b may occur slightly before step 1a and vice versa).

At step 1a, the digital asset-based interaction computing entity 16 performs a real-time digital asset-based interaction process 70 ensure complete the real-time digital asset-based interaction between the source and destination computing entities 12-14. To perform the real-time digital asset-based interaction process, the digital asset-based interaction computing entity 16 is operable to connect to the one or more digital asset exchange computing entities 22 to convert the digital assets 34 to a substantially equivalent amount of desired assets (e.g., fiat currency, another digital asset, whatever asset format is desired by the destination computing entity 14) and send the desired assets to the destination computing entity 14. The real-time digital asset-based interaction process 70 will be discussed in greater detail with reference to one or more other Figures.

At step 1b, the digital asset-based interaction computing entity 16 performs a nonreal-time digital asset-based interaction process 72 to reconcile the real-time digital asset-based interaction process with the digital asset backing computing entity 20. To perform the nonreal-time digital asset-based interaction process 72, the digital asset-based interaction computing entity 16 is operable to communicate with the digital asset backing computing entity 20 to back digital asset-based interactions such that they can be authorized and/or completed successfully in real-time and connect to the digital asset DLT network 28 associated with the digital assets 34 to verify receipt of digital assets 34. In another embodiment, the digital asset-based interaction computing entity 16 includes the digital asset backing computing entity 20. The nonreal-time digital asset-based interaction process will be discussed in greater detail with reference to one or more other Figures.

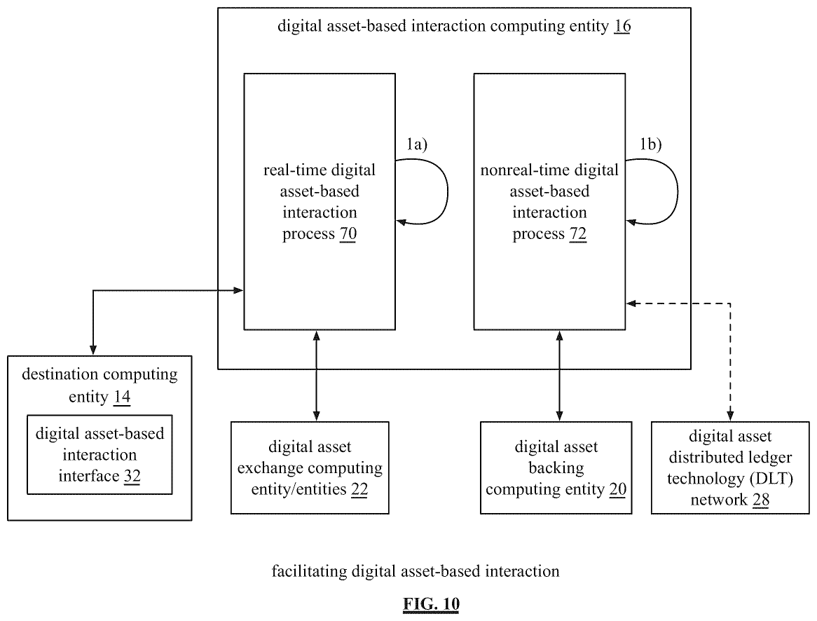

FIG. 11 is a flowchart of an example of a method of a real-time digital asset-based interaction process 70 executable by a digital asset-based interaction computing entity of a digital asset-based interaction system. The method begins with step 74 where the digital asset-based interaction computing entity obtains an amount of digital assets from a source computing entity to use in a digital asset-based interaction. The digital asset-based interaction involves a source computing entity providing digital assets and a destination computing entity accepting desired assets. The destination computing entity is associated with the digital asset-based interaction computing entity.

When the amount of the digital assets obtained by the digital asset-based interaction computing entity from the source computing entity to use in the digital asset-based interaction, a network acknowledgment (ACK) of the receipt of the amount of the digital assets is generated and an authorization process begins.

Because the digital assets sent by the source computing entity are managed by a digital asset distributed ledger technology network (e.g., the digital assets are cryptocurrency), sending the amount of digital assets to the digital asset-based interaction computing entity is a transaction added to the digital asset DLT network associated with the digital assets used by the source computing entity (e.g., this information is published). However, other details related to the interaction (e.g., the identity of the destination computing entity, transaction fees owed by the destination computing entity, etc.) may be managed privately by the digital asset-based interaction computing entity off-ledger (i.e., off-chain when the distributed ledger technology is blockchain). Therefore, the digital asset-based interaction system is operable to keep confidential destination computing entity related information (e.g., revenue, consumer spending behavior, etc.) and confidential source computing entity related information (e.g., consumer identity of purchases, amount spent at a particular merchant, payees/merchants frequented, etc.) private (i.e., not published on a blockchain for anyone to see).

When the digital asset-based interaction is authorized (e.g., the authorization process is successful), the method continues with step 76 where the digital asset-based interaction computing entity connects to one or more digital asset exchange entities to exchange the amount of the digital assets received from the source computing entity to an amount of desired assets. Digital asset exchange is done quickly (e.g., 30 seconds to a few minutes) to account for exchange rate volatility. The exchange can also be performed immediately on a credit-based account to eliminate any pricing volatility.

The method continues with step 78 where the digital asset-based interaction computing entity sends the amount of desired assets to the destination computing entity. For example, the digital asset-based interaction computing entity sends the desired assets to a banking computing entity associated with the destination computing entity. As another example, the digital asset-based interaction computing entity directs the desired assets to a wallet address associated with the destination computing entity.

FIG. 12 is a flowchart of an example of a method of a nonreal-time digital asset-based interaction process 72 executable by a digital asset-based interaction computing entity of a digital asset-based interaction system. The nonreal-time digital asset-based interaction process 72 of FIG. 12 begins concurrently with the real-time digital asset-based interaction process 70 of FIG. 11. However, the nonreal-time digital asset-based interaction process 116 occurs over a longer period of time (e.g., minutes to hours) than the real-time digital asset-based interaction process 70 (e.g., seconds).

The method begins with step 80 where the digital asset-based interaction computing entity instructs a digital asset backing computing entity of the digital asset-based interaction system to lock an amount of system digital assets stored in a transformer pool associated with the digital asset distributed ledger technology (DLT) network associated with the digital assets involved in the digital asset-based interaction. The digital asset-based interaction involves a source computing entity providing the digital assets and a destination computing entity accepting desired assets. The destination computing entity is associated with the digital asset-based interaction computing entity.

The digital asset backing computing entity may be a part of or separate from the digital asset-based interaction computing entity. The digital asset backing computing entity manages the storage and use of system digital assets (e.g., system cryptocurrency, system tokens, etc.) for collaterally backing digital asset-based interactions. System digital assets are digital assets that serve as collateral to back digital asset-based interactions of the digital asset-based interaction system. One or more staking computing entities provide the digital asset backing computing entity with system digital assets and instructions on how to stake the system digital assets. For example, one or more staking computing entities provided the digital asset backing computing entity system digital assets to back a digital asset DLT network associated with the digital assets used by the source computing entity in the digital asset-based interaction. A transformer pool is a smart contract that stores system digital assets to back the digital asset DLT network.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be a certain amount more than the amount of the digital asset-based interaction when certain types of goods, such as luxury goods, are involved), source computing entity information (e.g., if the source computing entity has a history of fraudulent interactions, the amount of system digital assets may be a certain amount more than the amount of the digital asset-based interaction), destination computing entity information (e.g., merchant-based requirements, default settings), a type of digital asset-based interaction (e.g., authorization holds such as for hotel room purchase may require a certain amount of system digital assets more than the amount of the digital asset-based interaction), digital asset backing computing entity default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital assets to the desired asset format (e.g., step 76 of FIG. 11), the digital asset-based interaction computing entity instructs the digital asset backing computing entity to release the amount of locked system digital assets (e.g., the method branches to step 80).

Step 80 of FIG. 12 may occur before, concurrently, or after step 74 (but before step 76 of FIG. 11. If step 80 occurs before step 74 of FIG. 11, an acknowledgement (ACK) may be generated. For example, locking the system digital assets implies authorization of the digital asset-based interaction, and the digital asset-based interaction computing entity allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity locks the amount of the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 82 where the digital asset-based interaction computing entity connects to the digital asset DLT network associated with the digital assets used by the source computing entity to verify obtaining the digital assets. The digital asset DLT network implements a validation procedure that may take minutes to hours of time.

For example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the source computing entity is using Bitcoin, the digital asset-based interaction computing entity seeks a desired number of confirmations of the amount of the Bitcoin received by the source computing entity from the digital asset DLT network (e.g., via Bitcoin miners). The transaction may not be verified by the digital asset-based interaction computing entity for an hour or more. As such, the nonreal-time digital asset-based interaction process takes longer than the real-time digital asset-based interaction process of the digital asset-based interaction.

The method continues with step 84 where the digital asset-based interaction computing entity determines whether the amount of digital assets is verified (e.g., the digital asset-based interaction computing entity obtains results from the digital asset DLT network regarding whether the amount of the digital assets is verified). When the amount of digital assets is verified, the method continues with step 88 where the digital asset-based interaction computing entity instructs the digital asset backing computing entity to release the amount of system digital assets associated with the digital asset-based interaction. When the amount of digital assets is not verified, the method continues with step 86 where the digital asset-based interaction computing entity instructs the digital asset backing computing entity to consume at least a portion of the amount of system digital assets associated with the digital asset-based interaction.

For example, if fraudulent activity occurs (e.g., the source computing entity acts maliciously to spend at two merchants simultaneously, software of the asset management unit is corrupted, etc.), the amount of the digital assets cannot be verified and the digital asset-based interaction computing entity consumes at least a portion of the amount of system digital assets associated with the digital asset-based interaction. As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

Consuming the amount of system digital assets means that the amount of system digital assets is transferred (e.g., via an on-chain transaction) from an address associated with the transformer pool to an address associated with the digital asset-based interaction computing entity. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

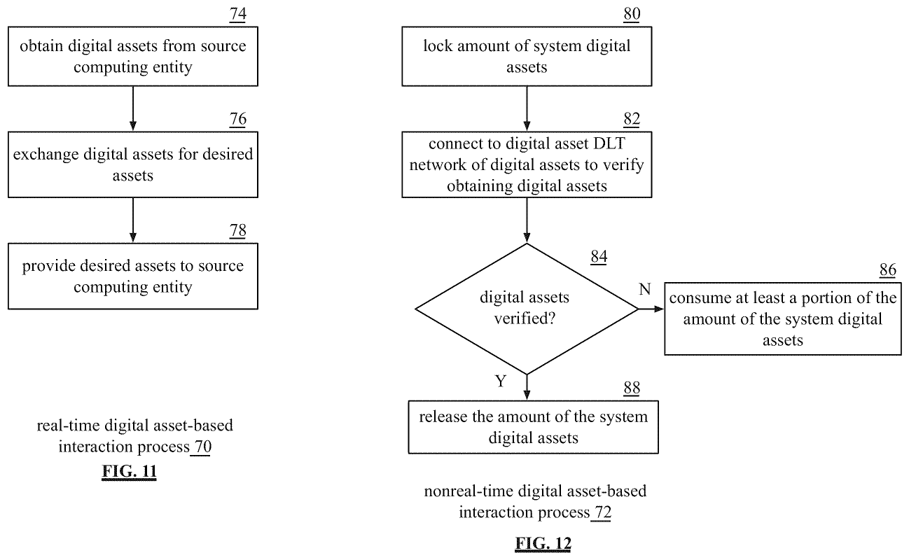

FIG. 13 is a flowchart of an example of a method of a real-time digital asset-based interaction process 70 executable by a digital asset-based interaction computing entity 16 of a digital asset-based interaction system. FIG. 13 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22.

The source computing entity 12, the destination computing entity 14, the interface means 18, the digital asset-based interaction computing entity 16, the digital asset backing computing entity 20, and the one or more digital asset exchange computing entities 22 of FIG. 13 operate similarly to the source computing entity 12, the destination computing entity 14, the interface means 18, the digital asset-based interaction computing entity 16, the digital asset backing computing entity 20, and the one or more digital asset exchange computing entities 22 of FIG. 1.

The destination computing entity 14 may be a merchant computing entity that is operable to process payments from a source computing entity and includes features tailored to the type of destination computing entity 14 it is (e.g., a scanning device, a touchscreen, mobile payment features, online payment features, etc.). The source computing entity 12 and the destination computing entity 14 interact via one or more interface means 18 to initiate a digital asset-based interaction. For example, an interface means 18 is a scanning device of the source computing entity 12 and/or the destination computing entity 14. A digital asset-based interaction involves the source computing entity 12 providing digital assets and the destination computing entity 14 accepting desired assets (e.g., fiat currency or a desired digital asset that differs from the digital asset the source computing entity 12 wishes to use in the interaction).

The method begins with step 1 where the source computing entity 12 connects to the digital asset-based interaction computing entity 16 with a user ID. For example, the source computing entity 12 interacts with the destination computing entity 14 via the interface means 18 to provide source inputs as discussed in one or more of the previous Figures. As a source input, the user ID is provided (e.g., through an interaction page, etc.) to the digital asset-based interaction computing entity 16. When the source computing entity 12 has not interacted with the digital asset-based interaction computing entity 16 before, the source computing entity 12 is prompted to provide a user ID or a user ID is automatically generated by the digital asset-based interaction computing entity 16 and assigned to the source computing entity 12.

The method continues with steps 2a and 2b. Steps 2a and 2b may occur concurrently, or one slightly before or after one another (e.g., step 2b occurs slightly before step 2a, etc.). At step 2a, the source computing entity directs an amount of digital assets 34 to the digital asset-based interaction computing entity 16 via the interface means 18. For example, the destination computing entity 14 provides the source computing entity 12 with a digital asset-based interaction request link (e.g., via a scannable code, a uniform resource locator (URL) link, etc.) to a digital asset-based interaction page that allows the source computing entity 12 to push digital assets to an address associated with the digital asset-based interaction computing entity 16. In this example, the source computing entity 12 is not associated with the digital asset-based interaction computing entity 16 (e.g., the source computing entity 12 does not include the digital asset-based interaction interface) so funds are pushed from the source computing entity 12 to the digital asset-based interaction computing entity 16.

At step 2b, the digital asset-based interaction computing entity 16 analyzes user preferences (if any) associated with the user ID. The user preferences may alert the digital asset-based interaction computing entity 16 to discounts available, loyalty information, payment preferences, digital asset preferences, etc.

The method continues with step 3 where a network acknowledgment (ACK) of the receipt of the amount of the digital assets and system digital assets locked (e.g., the nonreal-time digital asset-based interaction process step of locking system digital assets occurs before, concurrently, or slightly after the digital assets are obtained) is generated. The method continues with step 4 where an authorization process begins. Authorizing the digital asset-based interaction after locking the system digital assets may be useful when there are multiple parties sharing the same ticket which would require the digital asset-based interaction computing entity 16 to collateralize each digital asset-based interaction involved (where each would need to be authorized separately).

By staking the digital asset DLT network associated with the digital assets 34 to allow source computing entities to use any asset management unit of their choosing for providing digital assets 34, the asset management units and source computing entities may not be associated with the digital asset-based interaction system 10 and could introduce fraud, risk, and errors to the system. To mitigate these issues, upon obtaining digital asset-based interaction information and/or digital assets for a digital asset-based interaction, the digital asset-based interaction computing entity includes a digital asset-based interaction authorization module operable to authorize the digital asset-based interaction by performing an authorization process. The authorization process involves comparing characteristics of the digital asset-based interaction with system authorization parameters related to the digital asset-based interaction to detect errors and/or fraudulent activity associated with the digital asset-based interaction.

The digital asset-based interaction characteristics include the digital asset-based interaction information (e.g., source computing entity information, destination computing entity information, item(s) involved in the digital asset-based interaction, the amount of the digital asset-based interaction, digital asset-based interaction metadata, etc.) and transaction data pertaining to the source computing entity sending digital assets to the digital asset-based interaction computing entity. The information contained in the transaction data depends on the type of digital asset and digital asset DLT network involved. For example, in an Ethereum transaction, transaction data includes the recipient (e.g., an address), a signature of the sender, a nonce, a value (e.g., the amount of the digital assets being sent), data, a gas limit, a max priority fee per gas, and a max fee per gas. The transaction data typically includes at least a signature (signed with a private key), an output (e.g., a destination for the funds), an amount (e.g., the amount involved in the transaction), and a transaction fee.

The system information includes historical data, user information, and/or system tolerance thresholds. The historical data may include past digital asset-based interaction information such as the information pertaining to the parties involved (e.g., source computing entity identifiers (IDs), destination computing entity identifiers (IDs), merchant information, etc.), digital asset-based interaction amounts, whether or not a digital asset-based interaction was successful, etc., as well as historical authorization information such as a list of users associated with unauthorized digital asset-based interactions and/or suspicious activity.

Suspicious activity could include errors (e.g., the amount of digital assets sent is less than or more than the amount owed for the digital asset-based interaction), transaction fee issues (e.g., a transaction fee is too low which could be an indication of potential fraud), repeated digital asset-based interaction terminations (e.g., the user has a history of initiating and canceling digital asset-based interactions), etc.

The system tolerance thresholds include ranges of tolerance to use in comparison situations. The system tolerance thresholds may be stored/generated as system information and provided to the comparison module to use in comparisons. For example, certain digital asset-based interaction characteristics may be compared with each other in accordance with a system tolerance threshold. For example, a system tolerance threshold for the amount of the digital asset-based interaction may be 0%. For example, if the source computing entity sends an amount of digital assets that is not exactly equal to the amount of the digital assets in the digital asset-based interaction as identified in the digital asset-based interaction information (e.g., it is too low or too high), the digital asset-based interaction may not be authorized.

User information includes identifying information of parties involved in past and/or current digital asset-based interactions as well as any personal information such as email address, username, password, physical address, loyalty information, etc. Historical user information may be stored with the historical data. In an example, a source computing entity may provide a username and password as identifying information while initiating a digital asset-based interaction. This username and password (e.g., digital asset-based interaction characteristics) will be cross referenced with username and password combinations stored in the user information (e.g., system authorization parameters) for errors and/or issues (e.g., the source computing entity may enter the wrong password associated with its source identifier (ID)).

The digital asset DLT network information includes any information of interest related to a particular digital asset DLT network. For example, the digital asset DLT network information may include price history of the digital assets, market capitalization, block information (e.g., when the digital asset DLT network is a blockchain), circulating supply of the digital assets, a maximum supply, the validation procedure used (e.g., a consensus algorithm such as proof of work or proof of stake), algorithms used, transaction data, validation procedure timing information (e.g., average confirmation time), mempool (e.g., a temporary storage area for transactions, a “memory pool”) information, transaction fees, validator rewards (e.g., a block reward), etc. The system authorization parameters may be generated based on a digital asset-based interaction to digital asset-based interaction basis and/or pre-generated.

The information contained in the transaction data depends on the type of digital asset and digital asset DLT network involved. For example, in an Ethereum transaction, transaction data includes the recipient (e.g., an address), a signature of the sender, a nonce, a value (e.g., the amount of the digital assets being sent), data, a gas limit, a max priority fee per gas, and a max fee per gas. The transaction data typically includes at least a signature (signed with a private key), an output (e.g., a destination for the funds), an amount (e.g., the amount involved in the transaction), and a transaction fee.

A favorable comparison may occur when a transaction fee (e.g., a digital asset-based interaction characteristic) is greater than or equal to a minimum transaction fee value (e.g., a system authorization parameter). When the comparison is favorable, the digital asset-based interaction computing entity authorizes the digital asset-based interaction. When the comparison is not favorable, the digital asset-based interaction computing entity does not authorize the digital asset-based interaction. For example, an unfavorable comparison may occur when a transaction fee (e.g., a digital asset-based interaction characteristic) is lower than a minimum transaction fee value (e.g., a system authorization parameter).

When the authorization process is successful, the method continues with step 5 where the digital asset-based interaction computing entity 16 connects to one or more digital asset exchange entities 22 to exchange the amount of the digital assets 34 received from the source computing entity 12 to an amount of desired assets 90 (e.g., fiat currency, a digital asset that differs from the digital assets 34). Digital asset exchange is done quickly (e.g., 30 seconds to a few minutes) to account for exchange rate volatility. The exchange can also be performed immediately on a credit-based account to eliminate any pricing volatility.

The method continues with step 6 where the digital asset-based interaction computing entity 16 sends the amount of the desired assets 90 to the destination computing entity 14 and limited user information (e.g., shipping address, loyalty number). For example, the digital asset-based interaction computing entity 16 sends the amount of the desired assets 90 to a banking computing entity associated with the destination computing entity 14. As another example, the digital asset-based interaction computing entity 16 directs the amount of the desired assets 90 to a wallet address associated with the destination computing entity 14. Based on the user preferences analyzed in step 2b, the digital asset-based interaction computing entity 16 may send a proxy email to establish a loyalty account, shipping information, a loyalty account number, etc. to apply to the digital asset-based interaction.

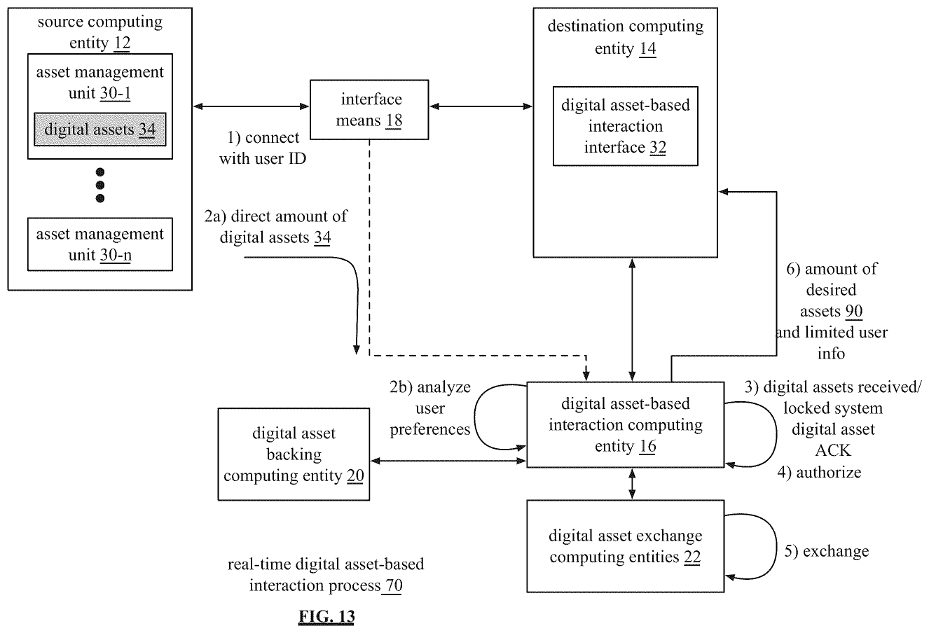

FIG. 14 is a flowchart of an example of a method of a real-time digital asset-based interaction process 70 executable by a digital asset-based interaction computing entity 16 of a digital asset-based interaction system 10. FIG. 14 depicts a portion of the digital asset-based interaction system 10 that includes a source computing entity 12, a destination computing entity 14, an interface means 18, a digital asset-based interaction computing entity 16, a digital asset backing computing entity 20, and one or more digital asset exchange computing entities 22. FIG. 14 operates similarly to the method of FIG. 13 except that the authorization process at step 4 occurs before the locked digital asset acknowledgment (ACK) is generated at step 5 and the locked system digital asset ACK is separate from the digital assets received ACK.

Locking the system digital assets after authorizing the digital asset-based interaction may be useful when authorizing straightforward digital asset-based interactions (e.g., a consumer paying for purchase at an apparel retailer). This would help reduce the unnecessary overhead of locking system digital assets for digital asset-based interactions that are declined. The authorization process will be discussed in more detail with reference to FIGS. 26-28.

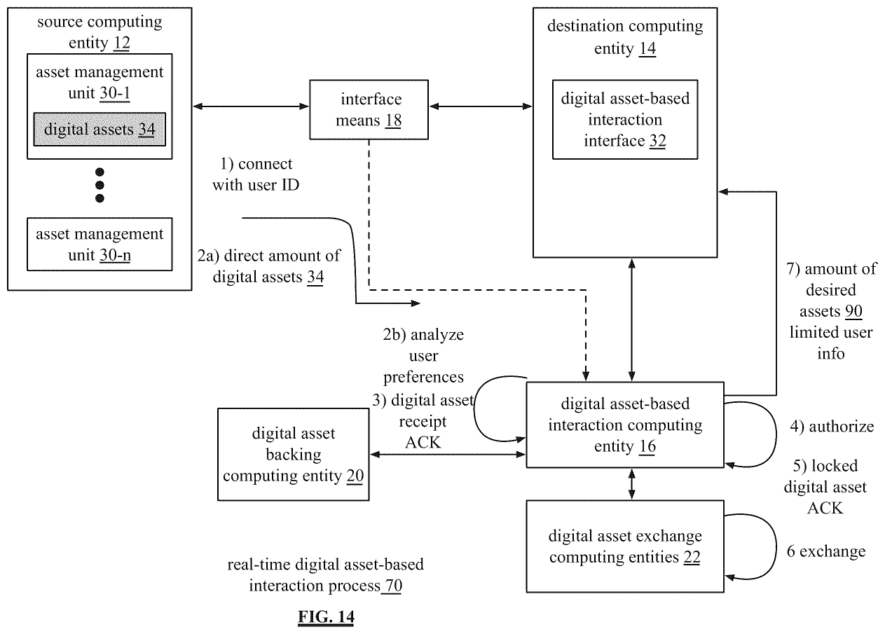

FIG. 15 is a flowchart of an example of a method of a real-time digital asset-based interaction process 70 executable by a digital asset-based interaction computing entity 16 of a digital asset-based interaction system. FIG. 15 depicts a portion of the digital asset-based interaction system that includes a source computing entity 12, a destination computing entity 14, an interface means 18, a digital asset-based interaction computing entity 16, a digital asset backing computing entity 20, and one or more digital asset exchange computing entities 22.

The method of FIG. 15 is similar to the method of FIG. 13 except that at step 2, an acknowledgment (ACK) is generated when an amount of system digital assets is locked to back the digital asset-based interaction (e.g., the digital assets have not been received yet). For example, locking the system digital assets (a step that occurs during the concurrent nonreal-time digital asset-based interaction process) implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.). At step 2 the digital asset-based interaction computing entity 16 is operable to analyze the user preferences associated with the user ID if there are any.

The method continues at step 3, where the digital asset-based interaction computing entity 16 sends the ACK to the destination computing entity 14. For example, when the destination computing entity is a POS computing device such as an attended register, this ACK may successfully end the in-person transaction such that a merchant and customer can part ways. However, the destination computing entity receives the payment up to a few minutes later.

The method continues with step 4 where the source computing entity 12 directs an amount of digital assets 34 to the digital asset-based interaction computing entity 16 via the interface means 18. For example, the destination computing entity 14 provides the source computing entity 12 with a digital asset-based interaction request link (e.g., via a scannable code, a uniform resource locator (URL) link, etc.) to a digital asset-based interaction page that provides the source computing entity 12 the ability to push digital assets to an address associated with the digital asset-based interaction computing entity 16 (e.g., via an interactive webpage). In this example, the source computing entity 12 is not associated with the digital asset-based interaction computing entity 16 so funds are pushed from the source computing entity 12 to the digital asset-based interaction computing entity 16.

The method continues with step 5 where receipt of the amount of the digital assets is generated, and an authorization process begins. When the authorization process is successful, the method continues with step 6 where the digital asset-based interaction computing entity 16 connects to one or more digital asset exchange entities 22 to exchange the amount of the digital assets 34 received from the source computing entity 12 to an amount of desired assets 134. Digital asset exchange is done quickly (e.g., 30 seconds to a few minutes) to account for exchange rate volatility. The exchange can also be performed immediately on a credit-based account to eliminate any pricing volatility.

The method continues with step 7 where the digital asset-based interaction computing entity 16 sends the amount of the desired assets 90 to the destination computing entity 14 along with limited user information (e.g., a loyalty number associated with the purchase, etc.). Alternatively, limited user information may be sent at step 3 when the locked system digital assets ACK is sent. The digital asset-based interaction computing entity 16 may send the amount of the desired assets 90 to a banking computing entity associated with the destination computing entity 14. As another example, the digital asset-based interaction computing entity 16 directs the amount of the desired assets 90 to a wallet address associated with the destination computing entity 14.

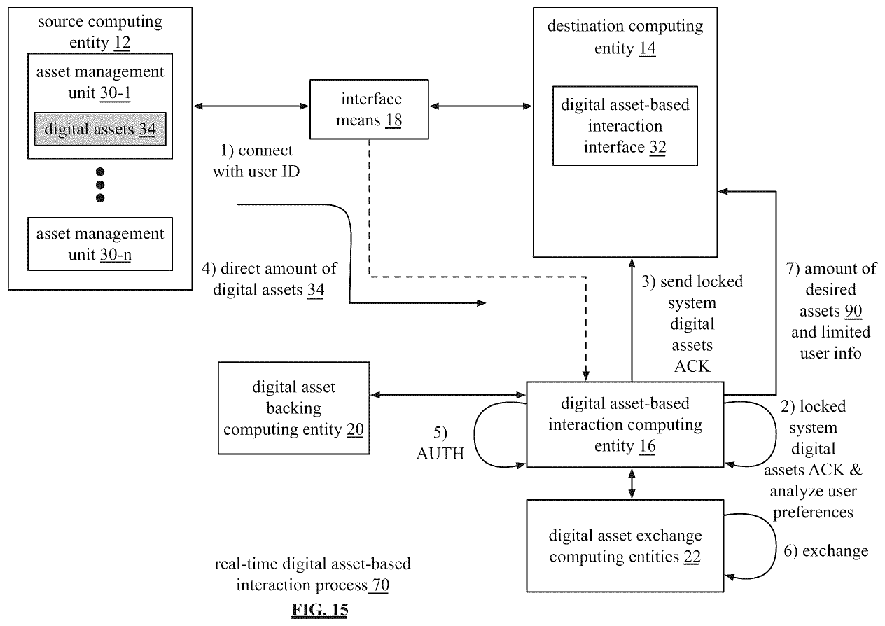

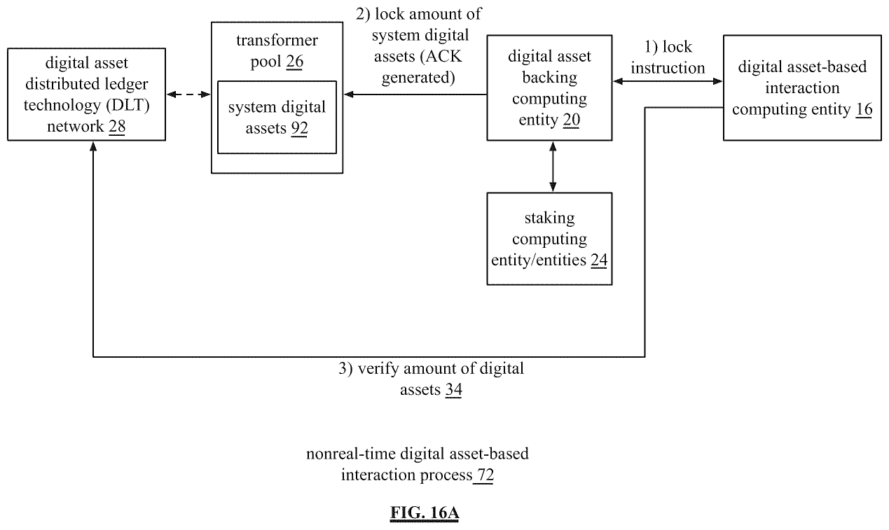

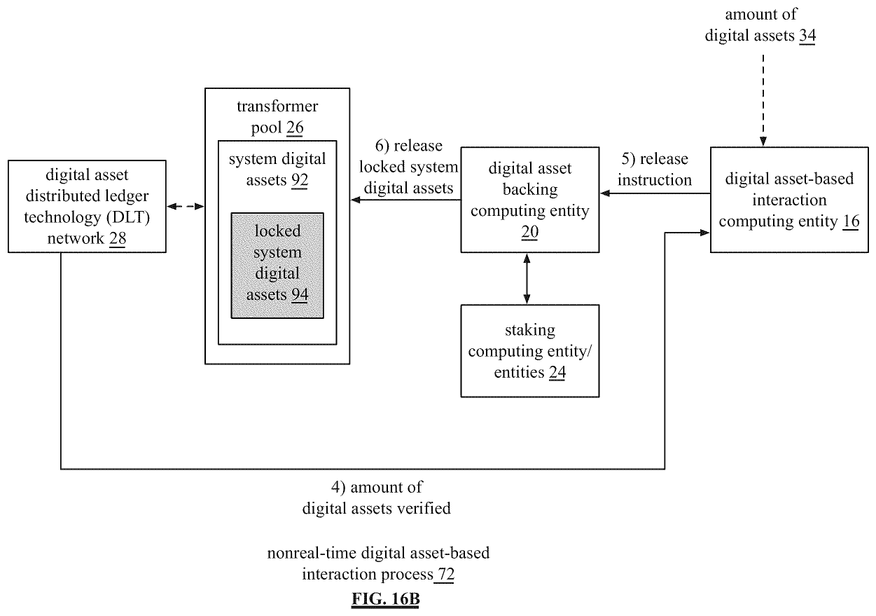

FIGS. 16A-16C are flowcharts of an example of a method of a nonreal-time digital asset-based interaction process 72 executable by a digital asset-based interaction computing entity of a digital asset-based interaction system. FIGS. 16A-16C depict a portion of the digital asset-based interaction system that includes a digital asset-based interaction computing entity 16, a digital asset backing computing entity 20, one or more staking computing entities 24, a transformer pool 26, and a digital asset distributed ledger technology (DLT) network 28.

The nonreal-time digital asset-based interaction process 72 of FIGS. 16A-16C begins concurrently with the real-time digital asset-based interaction process 70 of FIGS. 13-15. However, the nonreal-time digital asset-based interaction process 72 occurs over a longer period of time (e.g., minutes to hours) than the real-time digital asset-based interaction process 70 (e.g., seconds).

The method begins with FIG. 16A at step 1 where the digital asset-based interaction computing entity 16 instructs the digital asset backing computing entity 20 of the digital asset-based interaction system to lock an amount of system digital assets 92 associated with a digital asset-based interaction. The digital asset-based interaction involves a source computing entity providing digital assets and a destination computing entity accepting desired assets. The destination computing entity is associated with the digital asset-based interaction computing entity.

The digital asset backing computing entity 20 may be a part of or separate from the digital asset-based interaction computing entity 16. The digital asset backing computing entity 20 manages the storage and use of system digital assets 92 (e.g., system cryptocurrency, system tokens, etc.) for collaterally backing digital asset-based interactions. System digital assets 92 are digital assets that serve as collateral to back digital asset-based interactions of the digital asset-based interaction system.

One or more staking computing entities 24 provide the digital asset backing computing entity 20 with system digital assets 92 and instructions on how to stake the system digital assets 92. In this example, the one or more staking computing entities 24 provided the digital asset backing computing entity 20 system digital assets 92 to back a digital asset DLT network 28 associated with the digital assets used by the source computing entity in the digital asset-based interaction. The digital asset backing computing entity 20 deposits system digital assets 92 in a transformer pool 26 associated with the digital asset DLT network 28 to back digital asset-based interactions associated with the digital asset DLT network 28. The transformer pool 26 is a smart contract that stores system digital assets 92 to back the digital asset DLT network 28. The one or more staking computing entities, the digital asset backing computing entity, and the transformer pool will be discussed in more detail with reference to FIG. 25.

The method continues with step 2 where the digital asset backing computing entity 20 locks an amount of system digital assets 92 within the transformer pool 26 to back the digital asset-based interaction. A system acknowledgment (ACK) that the system digital assets have been locked may be generated. The ACK triggers a portion of the real-time digital asset-based interaction process (e.g., digital asset exchange can occur now that the system digital assets are locked, etc.) or can end an in-person transaction where the ACK serves as authorization of the digital asset-based interaction.

The amount of system digital assets locked may be based on a variety of factors such as the amount of the digital asset-based interaction (e.g., the amount of system digital assets is substantially equivalent to the amount of the digital asset-based interaction), the item involved in the digital asset-based interaction (e.g., the amount of system digital assets may be more than the amount of the digital asset-based interaction when certain types of goods, such as luxury goods, are involved), source computing entity information (e.g., if the source computing entity has a history of fraudulent interactions, the amount of system digital assets may be more than the amount of the digital asset-based interaction), destination computing entity information (e.g., merchant-based requirements, default settings), a type of digital asset-based interaction (e.g., authorization holds such as for hotel room purchase may require a larger amount of system digital assets than the amount of the digital asset-based interaction), digital asset backing computing entity 16 default settings, etc.

If the digital asset-based interaction initiation is terminated (e.g., interaction initiation fails and/or is cancelled by the source and/or the destination computing entity) or the digital asset-based interaction is not authorized during the authorization process within a certain amount of time prior to the digital asset-based interaction computing entity exchanging the digital asset to the desired asset format, the digital asset-based interaction computing entity instructs the digital asset backing computing entity to release the amount of locked system digital asset.

Step 2 of FIG. 16A may occur before, concurrently, or after obtaining digital assets from the source computing entity (but before exchanging digital assets for desired assets). If step 2 occurs before obtaining digital assets, an acknowledgement (ACK) may be generated. For example, locking the system digital assets implies authorization of the digital asset-based interaction, and the digital asset-based interaction computing entity 16 allows a time period (e.g., up to five minutes) prior to obtaining digital assets from the source computing entity (e.g., the first computing entity has time to add tip, split payment with another user, adjust type of digital asset used, etc.). The destination computing entity is provided a confirmation of this ACK. For example, when the destination computing entity is a POS computing device such as an attended register, this ACK may successfully end the in-person transaction such that a merchant and customer can part ways. However, the destination computing entity receives the payment up to a few minutes later.

When the digital asset backing computing entity 16 locks the system digital assets, a rate quote for the amount of digital assets used by the source computing entity is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 3 where the digital asset-based interaction computing entity 16 connects to the digital asset DLT network 28 associated with the digital assets 34 used by the source computing entity to verify obtaining the digital assets 34. The digital asset DLT network 28 implements a validation procedure that may take minutes to hours of time.

The method continues with FIG. 16B with step 4 where the amount of digital assets is verified. The method continues with step 5 where the digital asset-based interaction computing entity 16 instructs the digital asset backing computing entity 20 to release the amount of system digital assets associated with the digital asset-based interaction (e.g., locked system digital assets 94). The method continues with step 6 where the digital asset backing computing entity 20 releases the locked system digital assets 94.

Alternatively, the method continues with FIG. 16C with alternative step 4 where the amount of digital assets is not verified. For example, if fraudulent activity occurs (e.g., the source computing entity acts maliciously to spend the same funds at two merchants simultaneously, software of the asset management unit is corrupted, etc.) the digital asset-based interaction computing entity consumes at least a portion of the amount of system digital assets associated with the digital asset-based interaction (e.g., locked system digital assets 92). As a specific example, if the source computing entity attempts to double spend a transaction, the verification (e.g., the desired number of confirmations in a Bitcoin blockchain example) will not be received and the digital asset-based interaction computing entity will not be able to verify the amount of the digital asset received by the source computing entity.

The method continues with step 5 where the digital asset-based interaction computing entity 16 instructs the digital asset backing computing entity 20 to consume at least a portion of the amount of system digital assets associated with the digital asset-based interaction (e.g., locked system digital assets 92).

Consuming the amount of system digital asset means that (at step 6) the amount of system digital assets is transferred (e.g., via an on-chain transaction) from an address associated with the transformer pool 26 to an address associated with the digital asset-based interaction computing entity 16. When the amount of system digital assets is more than the amount of the digital asset-based interaction, only a portion of the amount of system digital assets (to cover the digital asset-based interaction) may be consumed while the remainder is unlocked. In another example, regardless of whether the amount of system digital assets is more than the amount of the digital asset-based interaction, the entire amount of the of system digital assets may be consumed.

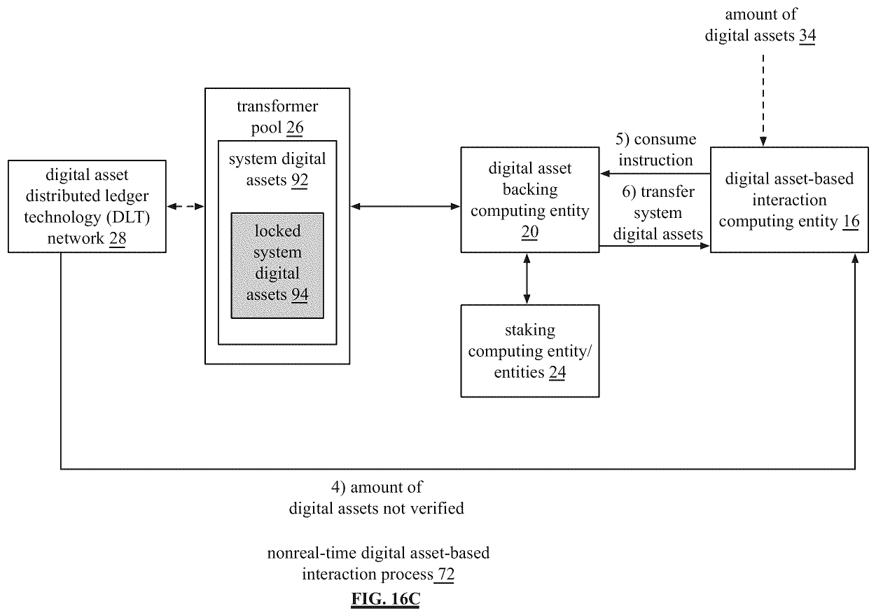

FIG. 17 is a flowchart of an example of a method of a digital asset-based interaction using a digital asset pushing code. In FIG. 17, the source computing entity 12 includes an asset management unit 30 that stores digital assets 34 and is associated with the digital asset-based interaction computing entity 16 via a digital asset-based interaction interface 32. The method begins with step 1 where the source computing entity 12 inputs a set of source inputs to the digital asset-based interaction computing entity 16 via the digital asset-based interaction interface 32. For example, the source computing entity 12 is operable to select a destination computing entity (e.g., via a searchable list of nearby merchants), a type of digital asset for a digital asset-based interaction, and a source of the digital asset (e.g., a particular asset management unit).

The method continues with step 2 where the source computing entity 12 sends digital asset-based interaction information to the digital asset-based interaction computing entity 16 via the digital asset-based interaction interface 32. The digital asset-based interaction information includes the set of source inputs (e.g., a source/user ID, a type of digital asset, etc.), and may further include an amount of the digital asset-based interaction, a type of digital asset-based interaction, one or more items included in a digital asset-based interaction, destination computing entity information (e.g., a merchant ID, etc.), etc.

Based on the digital asset-based interaction information, the method continues with step 3 where the digital asset-based interaction computing entity 16 generates and provides a digital asset pushing code to the source computing entity 12. The digital asset pushing code is an innocuous one-time code. For example, the digital asset pushing code is a scannable code that authorizes an amount of digital assets to be pushed to a location. At step 4, the source computing entity 12 provides the digital asset pushing code to the destination computing entity 14 via one or more interface means 18. The format of the digital asset pushing code generated may depend on the POS requirements of the destination computing entity 14. For example, a scannable code generated depends on the scanning technology used by the destination computing entity. A destination computing entity may also require the digital asset-based computing entity 16 to generate and send a verification code along with a scannable code. For example, a verification code is an alpha numeric code that can be manually entered or scanned by the destination computing entity.

The digital asset pushing code authorizes a digital asset-based interaction for up to a certain amount (e.g., X amount) for a time period (e.g., 5-30 seconds). The certain amount authorized may be based on one or more of the amount of system digital asset locked, the source computing entity 12, and the destination computing entity 14.

The time period may be a few seconds up to a few minutes of time depending on the source computing entity 12, the type of digital asset-based interaction, and/or the destination computing entity 14. For example, a fast food retail payment may have a shorter time period than a car purchase payment because the car purchase may involve lengthy paperwork and identity verification checks coinciding with payment. If the time period expires prior to real-time digital asset-based interaction confirmation, the digital asset pushing mechanism may no longer be valid and the source computing entity will need to request a new digital asset pushing request. Alternatively, the digital asset-based interaction computing entity 16 may automatically send a new digital asset pushing request to the source computing entity 12 every few seconds for a time period (e.g., up to 5 minutes) before the source computing entity 12 would need to request a new authorization scannable code.

At step 5, the destination computing entity 14 processes the digital asset pushing code (e.g., scans the scannable code via a scanning device of the destination computing entity 14). For example, a user of the source computing entity 12 places the source computing entity 12 display near a scanning device of the destination computing entity 14 (e.g., the destination computing entity 14 is a tablet and the scanning device is a front or back camera) for the destination computing entity 14 to capture a scannable digital asset pushing code. In that example, the destination computing entity 14 may be an unattended POS register (e.g., at a retail kiosk, self-checkout location, a gas pump checkout, a vending machine, etc.).

In addition to processing the code, the destination computing entity 14 may present a scannable code to the source computing entity 12 such as an “apply discount” code. If the source computing entity 12 scans the destination computing entity 14 code, the information is provided to the digital asset-based interaction computing entity 16 to apply to the digital asset-based interaction.

The method continues with step 6 where, when the destination computing entity 14 processes the digital asset pushing code, the destination computing entity 14 sends destination digital asset-based interaction information to the digital asset-based interaction computing entity 16. The destination digital asset-based interaction information includes an identifier (ID) (e.g., a merchant ID) and a type of desired digital asset (e.g., a fiat currency, a different cryptocurrency, etc.) it wishes to receive in the digital asset-based interaction with the source computing entity 12. The destination digital asset-based interaction information also includes the amount of the digital asset-based interaction in this example. The destination digital asset-based interaction information may include other information and/or metadata such as discounts offered and/or applied, shipping details (rates, method, etc.), bill splitting options, etc.

When the digital asset-based interaction computing entity 16 receives the destination digital asset-based interaction information, the method continues with step 7 where the digital asset-based interaction computing entity 16 goes on to facilitate the digital asset-based interaction.

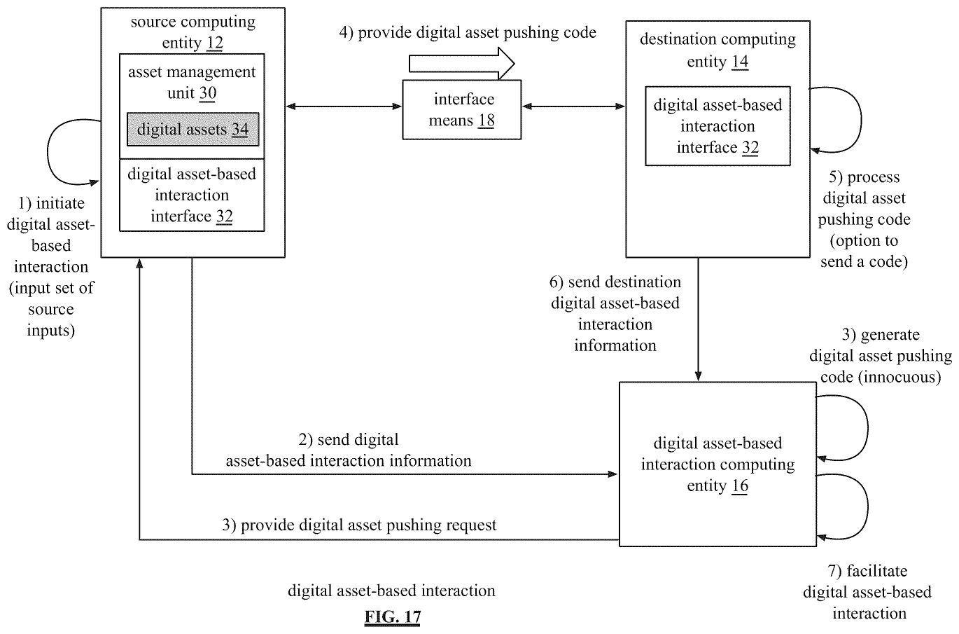

FIG. 18 is a schematic block diagram of an embodiment of a source computing entity 12 that includes an asset management unit 30 having a digital asset-based interaction interface 32 associated with a digital asset-based interaction computing entity. The digital asset-based interaction interface 32 interfaces with the digital asset-based interaction computing entity. FIG. 18 depicts a user interface perspective of the source computing entity 12 and further includes a display 100, a front scanning device 96, and a back scanning device 98.

In the user interface perspective, the digital asset-based interaction interface 32 includes balances 102, a scannable code module 104, and a destination computing entity selection module 106. The balance(s) 102 may include account balances for a variety of digital assets (e.g., cryptocurrencies, fiat, etc.) of a variety of asset management units. The balance(s) 102 are based on rate quotes determined by a digital asset exchange computing entity used by the digital asset-based interaction computing entity 16 at a point in time (e.g., a current exchange rate, an average exchange rate for a time period, etc.). The scannable code module 104 is operable to display scannable codes on the display 100 and interpret scannable codes captured via the scanning devices. The destination computing entity selection module 106 is operable to connect to the digital asset-based interaction computing entity and/or a database associated with the digital asset-based interaction computing entity to receive destination computing entity data (e.g., a list of merchants associated with the digital asset-based interaction system).

The destination computing entity selection module 106 may display a list of merchants that are associated with the digital asset-based interaction system for selection by the source computing entity 12. The destination computing entity selection module 106 includes a search function to allow a user to search for a desired destination computing entity. The displayed list of destination computing entities may be based on location (e.g., nearby merchants are listed), category (e.g., restaurant merchants are listed), and/or availability (e.g., according to hours of operation). In another embodiment, the source computing entity 12 is able to locate and initiate a digital asset-based interaction with user computing device of the digital asset-based interaction system (e.g., where destination computing entity selection module 106 further includes a user computing device selection function).

Referring to the method of FIG. 17, a user of the source computing entity 12 initiates a digital asset-based interaction by selecting a destination computing entity (destination computing entity 1 in this example) from a displayed list of destination computing entities in the destination computing entity selection module 106. When selected, the source computing entity 12 receives a digital asset pushing code 108 (shown here as a scannable code and a verification code 110) (e.g., the destination computing entity 14 requires a verification code along with a scannable code to authorize the digital asset-based interaction) from the digital asset-based interaction computing entity. The digital asset pushing code 108 and the verification code 110 are innocuous (do not contain any personal information regarding the source computing entity) one-time codes and are displayed within the scannable code module 104 of the source computing entity's 12 display 100. The source computing entity 12 is operable to present the digital asset pushing code 108 and the verification code 110 (when included) to a destination computing entity to engage in a digital asset-based interaction.

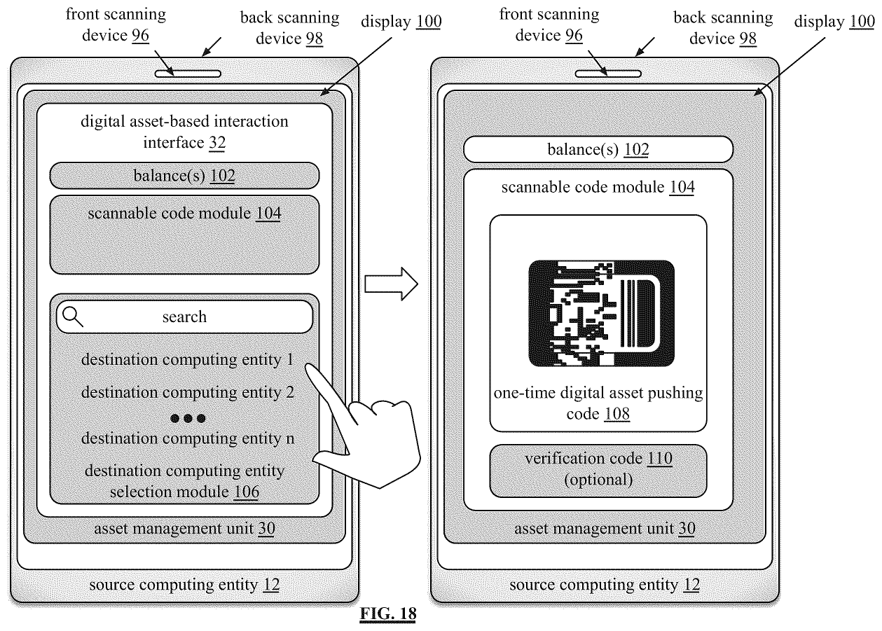

FIG. 19 is a schematic block diagram of an embodiment of a source computing entity 12 that includes an asset management unit 30-1 having a digital asset-based interaction interface 32 associated with a digital asset-based interaction computing entity. The digital asset-based interaction interface 32 interfaces with the digital asset-based interaction computing entity. FIG. 19 depicts a user interface perspective of the source computing entity 12 and further includes a display 100, a front scanning device 96, and a back scanning device 98.

In the user interface perspective, the digital asset-based interaction interface 32 includes balances 102, a scannable code module 104, and a destination computing entity selection module 106 as discussed with reference to FIG. 18.

In this example, the source computing entity 12 further includes an asset management unit 30-2 and a code storage and display application 112. The code storage and display application 112 is an application that stores and organizes codes (e.g., barcodes, QR codes, etc.) such as those included on tickets, passes, identification mechanisms, etc.

The source computing entity 12 is operable to move a digital asset pushing code from the scannable code mode 104 to the code storage and display application 112 to store and use at a later date. When the digital asset pushing code 108 is opened from the code storage and display application 112, the source computing entity 12 can display the digital asset pushing code 108 to a destination computing entity via the display functionality of the code storage and display application 112. In another example, opening/selecting the digital asset pushing code 108 from the code storage and display application 112 establishes a deep link with the asset management unit associated with the digital asset-based interaction (e.g., the asset management unit 30-2 in this example).

For example, when generating the digital asset pushing code 108 for the source computing entity 12, the digital asset-based interaction computing entity 16 analyzes user preferences associated with the source computing entity 12 to determine which asset management unit the source computing entity wishes to use for the digital asset-based interaction and embeds that information in the digital asset pushing code 108. In another example, the source computing entity 12 informs the digital asset-based interaction computing entity 16 of a selected asset management unit as a user input.

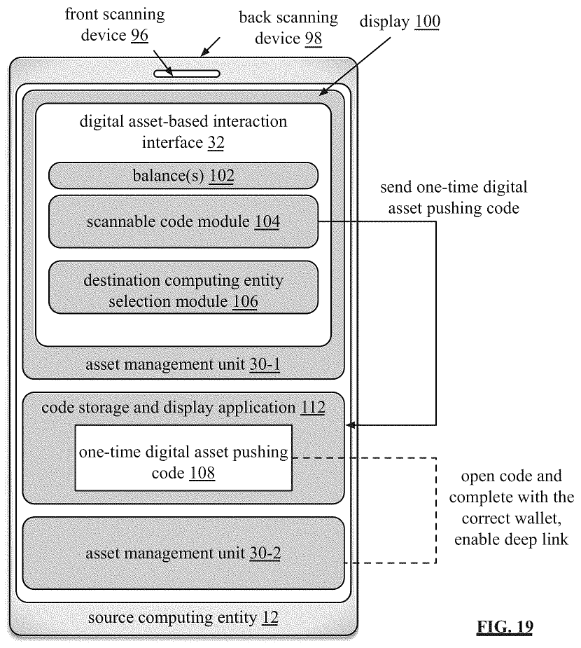

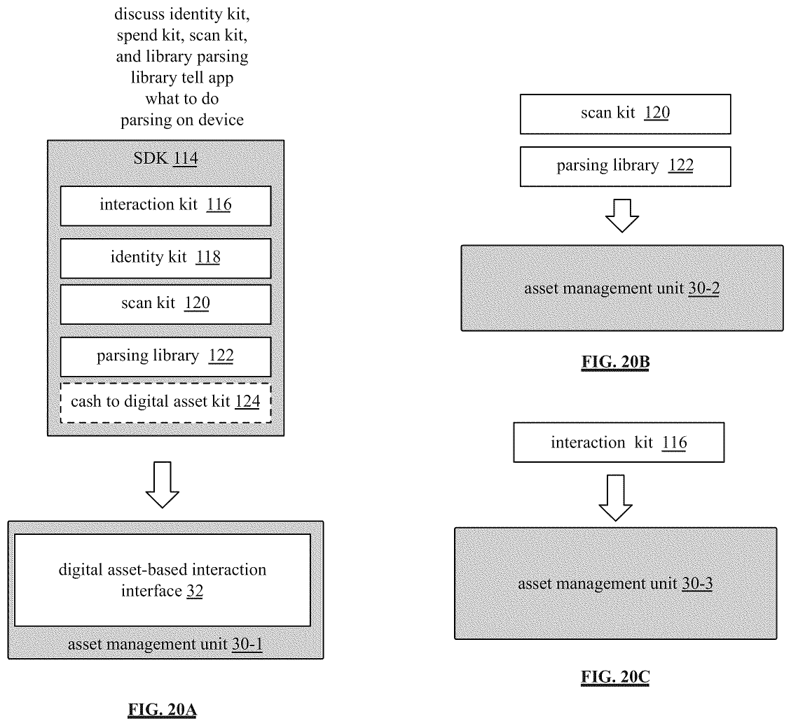

FIGS. 20A-20C are schematic block diagrams of embodiments of asset management units. FIG. 20A includes an asset management unit 30-1 having a digital asset-based interaction interface 32 associated with a digital asset-based interaction computing entity. The asset management unit 30-1 is a digital wallet that was developed using a software development kit (SDK) 114. An SDK is a set of software building tools used to build software applications. An SDK can be downloaded and installed for a particular platform. The SDK 114 includes an interaction kit 116, an identity kit 118, a scan kit 120, and a parsing library 122. The SDK 114 may also include a cash to digital asset kit 124. The interaction kit 116 includes the tools necessary to obtain user presented digital asset pushing codes and to process destination computing entity presented codes. The identity kit 118 includes the tools necessary to gather information from a user, enable a link to a user ID, personal details, verification status, spending limits, age verification person, etc. A portable user ID could be used across all wallets as a passport of sorts.

The scan kit 120 includes the tools necessary to build a code interface and processing module. The code interface is operable to scan different codes and determine what asset management unit should be accessed to process the code. The code interface is further operable to scan different codes and determine what assets are involved. The parsing library 122 is operable to parse information to instruct an application what to do with data. For example, a scannable code can be parsed and the parsing library determines that based on data in the code, the digital asset-based interaction could be processed by a certain asset management unit and connect to the asset management unit via a deep link. In another example, a scannable code can be parsed and the parsing library determines that based on data in the code, the digital asset-based interaction could be processed by more than one asset management units. The user could be presented with an option on which asset management unit to use or a deep link may connect the user to a preferred asset management unit of the options available. A level of parsing is kept on device and can be used when there is no network connection (e.g., no information or connection shared with the digital asset-based interaction computing entity). The cash to digital asset kit 124 will be discussed in further detail with reference to one or more of the subsequent Figures.

FIG. 20B depicts an example of an asset management unit 30-2 that is developed using the scan kit 120 and parsing library 122 to interpret different kinds of codes and FIG. 20C depicts an example of an asset management unit 30-3 that is developed using the interaction kit 116 to obtain and send codes for digital asset-based interactions. FIGS. 20B-20C are examples that one or more components of the SDK 114 can be used individually or in combination based on the needs of various asset management units.

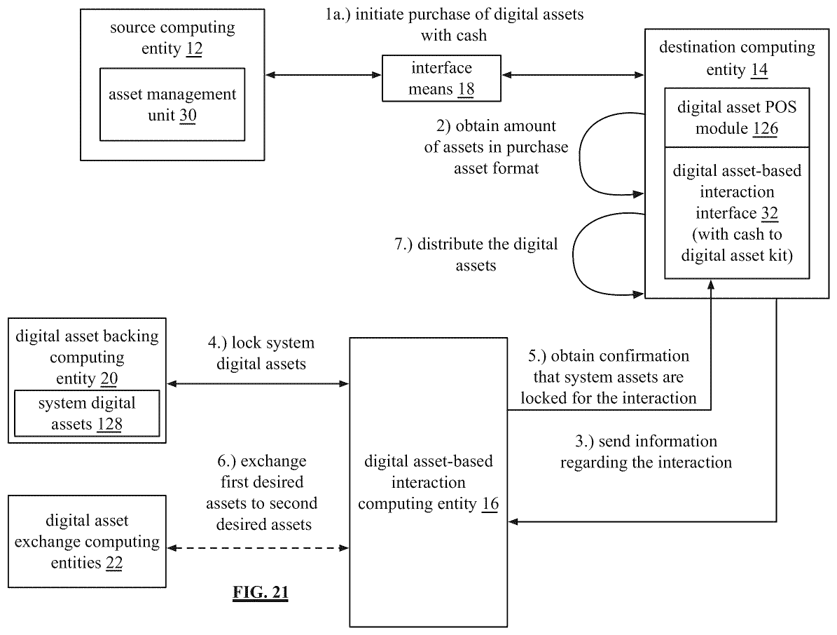

FIG. 21 is a flowchart of an example of a method of a real-time purchase of digital assets using cash of a digital asset-based interaction system. FIG. 21 includes the source computing entity 12, the destination computing entity 14, the digital asset-based interaction computing entity 16, the digital asset backing computing entity 20, and the one or more digital asset exchange computing entities 22 of the digital asset-based interaction system and depicts a real-time digital asset-based interaction where the interaction is purchasing digital assets with cash (e.g., fiat currency).

In this example, the destination computing entity 14 includes the digital asset-based interaction interface 32 that includes to the cash to digital asset kit that facilitates obtaining cash deposits for digital assets. The destination computing entity 14 may further include a digital asset point-of-sale (POS) module 126 that facilitates sending and/or receiving assets during an interaction and includes POS software and/or hardware with payment features tailored to a type of destination computing entity 14. For example, the destination computing entity 14 may include one or more scanning devices, touchscreens, receipt printer, digital asset and/or currency storage devices, fiat currency dispensers and/or acceptors, etc., and any processing software related to those features.

The method begins with step 1 where the digital asset purchase with cash is initiated between the source computing entity 12 and the destination computing entity 14 via the interface means 18 or directly by user input. For example, the source computing entity 12 may use prompts displayed on the destination computing entity 14 to initiate the digital asset purchase. For example, the destination computing entity 14 displays options for digital assets available for purchase and the source computing entity selects the desired options. In another example, the destination computing entity 14 provides a scannable code that connects the source computing entity 12 to a digital asset-based interaction page where the source computing entity 12 can see options and input information.

At step 2, the destination computing entity 14 obtains an amount of cash from the user of the source computing entity 12. The bi-directional digital asset POS computing device 14 receives the amount of cash directly from the source computing entity 12 (e.g., a user of the user computing device 12 inserts fiat currency into the destination computing entity 14).

The method continues with step 3, where the destination computing entity 14 sends information regarding the interaction to the digital asset-based interaction computing entity 16. The information includes destination computing entity 14 information and may also include limited source computing entity 12 information where the destination computing entity 14 obtains source computing entity 12 from the source computing entity 12 via the interface means 18. In another example, the source computing entity 12 sends source computing entity 12 information regarding the interaction to the digital asset-based interaction computing entity 16 (when the source computing entity 12 includes a digital asset-based interaction interface) and the destination computing entity 14 sends the destination computing entity information to the digital asset-based interaction computing entity 16.

The information includes one or more identifiers (e.g., a user ID, a merchant ID, a terminal ID of the destination computing entity 14), a type of the digital asset-based interaction (e.g., the digital asset purchase), the purchase asset format (e.g., a user desired fiat currency), a digital asset type, and an amount of the purchase. The information may include further information and/or metadata such as transaction fees, loyalty information, personal information (address, name, etc.), a request for additional information, etc.

The method continues with step 4, where based on the interaction initiation (e.g., receiving the information), the digital asset-based interaction computing entity 16 locks an amount of system digital assets 128 stored by the digital asset backing computing entity 20 to back the interaction. The amount of system digital asset locked may be based on one or more of an amount involved in the interaction, a type of asset involved in the interaction, a type of the interaction, a type of item involved in the interaction, the source computing entity 12 (e.g., a typical amount the source computing entity 12 spends, an account balance, trading behavior of the source computing entity 12, etc.), and the destination computing entity 14 (e.g., the type of merchant the destination computing entity 14 is associated with, a type of goods the merchant sells, a default amount set by the merchant, etc.).

When the digital asset-based interaction computing entity 16 locks the system digital asset, a rate quote for the cash to the digital asset exchange may also be locked. The digital asset-based interaction computing entity 16 connects to or maintains a connection to the one or more digital asset exchange computing entities 22 to obtain the rate quote and is operable to adjust the rate quotes according to an asset's availability on the exchange. Because the system digital assets are locked to back the cash purchase of digital assets, finality of a blockchain and thus a cash deposit is detected.

The digital asset-based interaction computing entity 16 may lock the rate quote based on a tolerance window acceptable to the user of the source computing entity 12. For example, the rate quote may be higher than a current rate quote if a longer window of time is provided to the source computing entity 12 to receive funds is longer. As another example, once a user authorizes a digital asset-based interaction, the assets in the purchase asset format may be exchanged by the digital asset-based interaction computing entity 16 (via the one or more digital asset exchange computing entities 22) on credit (even if it has not been received yet) with the exchange to ensure a particular rate quote. Once the amount of the assets in the purchase asset format is received from the source computing entity 12, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in the purchase asset format. When the amount of assets in the purchase asset format are received by the digital asset-based interaction computing entity 16, the digital asset-based interaction computing entity 16 is operable to exchange (via the one or more digital asset exchange computing entities 22) the amount of the assets in the purchase asset format to the substantially equivalent amount of the smart contract compatible token used to cover the real-time digital asset exchange.

The method continues with step 5. At step 5, the destination computing entity 14 receives a confirmation from the digital asset-based interaction computing entity 16 that the amount of system digital assets have been locked to back the interaction. If the interaction is terminated (e.g., digital asset-based interaction initiation fails and/or is cancelled by the source computing entity 12 and/or the destination computing entity 14) prior to step 6 (i.e., no exchange has occurred), the interaction is terminated and the digital asset-based interaction computing entity 16 instructs the digital asset backing computing entity 20 to release the amount of locked system digital assets. If the assets in the purchase asset format have been obtained prior to the termination, the transaction can be cancelled and/or the source computing entity 12 can be refunded (e.g., in the situation where the user computing device deposits fiat currency into the destination computing entity 14).

The method continues at step 6 where the digital asset-based interaction computing entity 16 connects to the one or more exchanging computing entities 22 of the digital asset-based interaction system to exchange the cash in the purchase asset format to an amount of digital assets where the amount of the assets in the purchase asset format is substantially equivalent to the amount of the digital assets. The digital asset exchange occurs quickly (e.g., 30 seconds to a few minutes) to account for exchange rate volatility and so that the destination computing entity 14 can provide and/or obtain desired assets in real-time.

When the destination computing entity 14 is operable to obtain fiat currency directly from the source computing entity 12 as the assets in the purchase asset format, the destination computing entity 14 maintains an account with the digital asset-based interaction computing entity 16 such that the digital asset-based interaction computing entity 16 can access funds from the bi-directional digital asset POS computing device 14 account for the exchange. The merchant associated with the destination computing entity 14 would then balance the accounting with the destination computing entity 14's account and the fiat currency received and stored within the with the destination computing entity 14.

The method continues with step 7 where the destination computing entity 14 distributes the digital assets to the source computing entity 12. For example, the destination computing entity 14 sends the amount of the digital assets to a location associated with the source computing entity 12 (e.g., information in the real-time information (obtained via scanning a code from the source computing entity 12) directs the amount of the second desired user assets from the digital asset-based interaction computing entity 16 (or one or more exchange entities) to a location associated with the source computing entity 12, etc.). For example, the destination computing entity 14 directs the amount of the digital assets to an address of the asset management unit 30 of the source computing entity 12. As another example, the destination computing entity 14 sends the amount of the digital assets to an address associated with a friend, family member, business associate, client, etc., of a user of source computing entity 12.

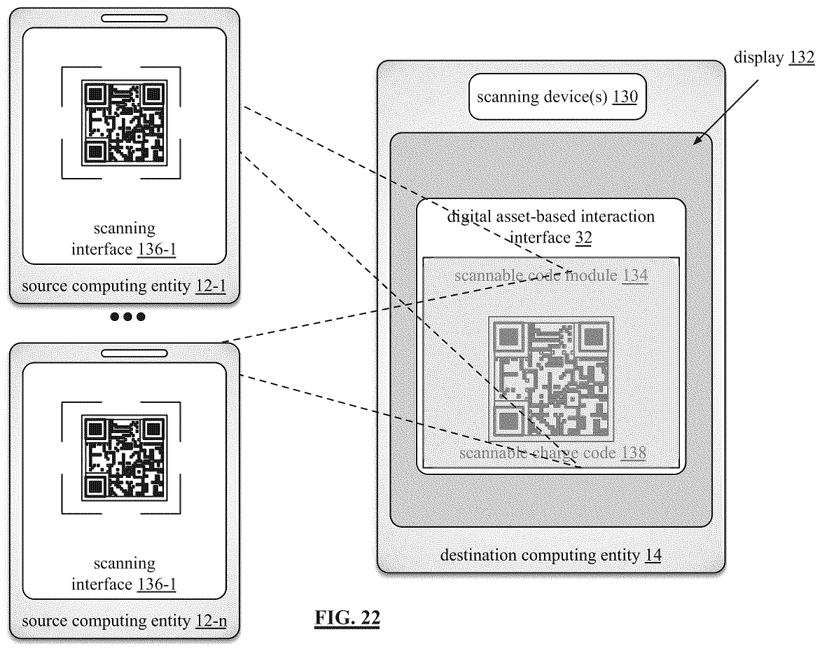

FIG. 22 is a schematic block diagram of a multi-party interaction of a digital asset-based interaction system. FIG. 22 depicts a user interface perspective of source computing entities 12-1 through 12-n and a destination computing entity 14. The source computing entities 12-1 through 12-n are shown in a simplified view and include scanning interfaces 136-1 through 136-2 performing a scanning function. Scanning interfaces 136-1 through 136-2 can be in any application and have the ability to interpret codes associated with the digital asset-based computing entity (e.g., the application has the “scan kit” of the SDK mentioned in previous Figures).

In this example, the destination computing entity 14 shown may be merchant POS device 14 that includes scanning device(s) 130 and a display 132. The destination computing entity 14 includes a digital asset-based interaction interface 32 that interfaces with the digital asset-based interaction computing entity. The digital asset-based interaction interface 32 includes a scannable code module 134 coupled to the scanning device(s) 130. The scannable code module 134 is operable to receive scannable codes (e.g., from the digital asset-based interaction computing entity), scan scannable codes (e.g., capture via the scanning device(s) 130, digitize, and bring into a frame of reference), display scannable codes on the display 132, and interpret scannable codes to determine and/or display payment information.

As shown, the destination computing entity 14 displays a scannable charge code 138 on a display 132 of the destination computing entity 14 for use in a digital asset-based interaction. As another example, the destination computing entity 14 prints a scannable charge code 138 (e.g., onto a receipt) and provides the printed scannable charge code 138 to one or more source computing entities 12-1 through 12-n. In that example, the destination computing entity 14 may not include a display 132 and/or scanning device(s) 130.

The source computing entities 12-1 through 12-n are each operable to scan the scannable charge code 138 via a back scanning device in this example (e.g., the back camera of a smart phone) coupled to the scanning interfaces 136-1 through 136-n. The scanning interfaces 136-1 through 136-n digitize the scannable charge code 138 and bring it into a frame of reference. The scanning interfaces 136-1 through 136-n analyze information in the scannable charge code 138 and present the information to the users when applicable. If the scannable charge code 138 includes requests and/or notifications from the destination computing entity 14, those requests and/or notifications are displayed via scanning interfaces 136-1 through 136-n or another portion of the source computing entities 12-1 through 12-n (e.g., scanning the scannable code opens a digital wallet for payment).

With more than one source computing entity operable to scan a scannable charge code, multiple payment options are possible (e.g., bill splitting at a restaurant, etc.). For example, a payment may be automatically split among the source computing entities (e.g., split equally between the users). As another example, when more than one source computing entity scans a scannable charge code 138, various bill splitting options (e.g., an equal split, custom, tip adding, etc.) may be selected or automatically shown.

While the source computing entities 12-1 through 12-n are shown scanning the scannable charge code 138, a source computing entity is operable to scan the scannable charge code 138 and send a request to another source computing entity to split the payment. Alternatively, the source computing entity is operable to scan and send the scannable charge code 138 to another source computing entity having a scanning interface 136.

The digital asset-based interaction information involving multiple parties is aggregated by the digital asset-based interaction computing entity such that individual source computing entities only see their private user preferences and not the preferences or digital asset-based interaction information of other source computing entities involved in the interaction (unless sharing is permitted between parties).

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for a secure interaction, the method comprises:
initiating, by a source computing entity or by a destination computing entity, a secure interaction with the other of the source computing entity or the destination computing entity, wherein:
the initiating the secure interaction includes informing, by the source computing entity or by the destination computing entity, an interaction computing entity of the initiated secure transaction; and
the secure interaction is regarding something of value;
determining, by the interaction computing entity, user preferences associated with the source computing entity based on a set of source inputs associated with the source computing entity, wherein:
the set of source inputs is digital information regarding the source computing entity and/or the secure interaction, and
the user preferences include identify of a cryptocurrency digital asset for which the source computing entity is offering to pay for the something of value;
determining, by the interaction computing entity, merchant preferences associated with the destination computing entity, wherein the merchant preferences include a preferred digital asset payment type;
establishing, by the interaction computing entity, digital asset exchange parameters for the secure interaction based on the user preferences and on the merchant preferences; and
facilitating, by the interaction computing entity, the secure interaction between the source computing entity and the destination computing entity based on the digital asset exchange parameters when the digital asset exchange parameters were confirmed by the source computing entity and/or the destination computing entity.

2. The method of claim 1, wherein the initiating the securing interaction further comprises:
accessing, by the source computing entity, a digital asset-based interaction page associated with the destination computing device, wherein the digital asset-based interaction page provides information regarding potential interactions supported by the destination computing entity.

3. The method of claim 1, wherein the informing the interaction computing entity further comprises:
sending, by the destination computing entity, a set of digital asset-based interaction inputs to the interaction computing entity, wherein the set of digital asset-based interaction inputs include digital information regarding the merchant preferences, which further include:
preferred types of interactions;
preferred digital asset payment types for different types of interactions;
preferred authentical mechanisms;
special offers for selected things of value; sand
special offers for selected users via their associated source computing entities.

4. The method of claim 1, wherein the informing the interaction computing entity further comprises:
sending, by the source computing entity, the set of source inputs to the interaction computing entity, wherein:
the digital information regarding the source computing entity includes one or more of:
a user identifier associated with the source computing entity;
a source computing entity identifier;
a user email address associated with the source computing entity;
a user physical address associated with the source computing entity;
a list of digital assets associated with a user via the source computing entity;
a source computing entity IP address;
access token information;
a user telephone number associated with the source computing entity; and
a customer loyalty number associated with the source computing entity or with the user identifier; and
the digital information regarding the secure interaction includes one or more of:
intent to initiate the secure interaction via:
sending a digital communication regarding initiating the secure interaction, or
scanning a code regarding the secure interaction;
identity of a digital asset source;
an offer for sale amount regarding the something of value; and
identity of the something of value.

5. The method of claim 1, wherein the determining the user preferences further comprises:
interpreting a smart contract associated with the source computing entity, wherein the smart contract includes a plurality of purchasing preferences of a user associated with the source computing device.

6. The method of claim 1, wherein the determining the merchant preferences further comprises:
interpreting a smart contract associated with the destination computing entity, wherein the smart contract includes a plurality of preferences of a merchant associated with the destination computing device.

7. The method of claim 1, wherein the establishing the digital asset exchange parameters further comprises one or more of:
establishing, as a first digital asset exchange parameter of the digital asset exchange parameters, proxy information regarding the user preferences of a user associated with the source computing entity;
establishing, as a second digital asset exchange parameter of the digital asset exchange parameters, sufficient staking of the cryptocurrency digital asset of the source computing entity for purchasing of the something of value;
establishing, as a third digital asset exchange parameter of the digital asset exchange parameters, a sales price for purchase of the something of value via the source computing entity by the associated user;
establishing, as a fourth digital asset exchange parameter of the digital asset exchange parameters, applicable customer loyalty benefits of the associated user regarding the purchasing of the something of value and/or purchasing via the destination computing entity associated with a merchant; and
establishing, as a fifth digital asset exchange parameter of the digital asset exchange parameters, an access token to ensure integrity of the secure interaction.

8. The method of claim 7, wherein the facilitating the secure interaction further comprises one or more of:
when sufficient staking of the cryptocurrency digital asset for the sales price for purchase of the something of value has been verified:
determining applicable customer loyalty benefits;
applying the applicable customer loyalty benefits to purchase of the something of value; and
executing the secure interaction using the proxy information regarding the associated user and/or of the source computing entity.

9. The method of claim 8 further comprises:
verifying the access token prior to verifying the sufficient staking;
when the access token is not verified, denying the secure interaction.

10. The method of claim 1 further comprises at least one of:
receiving, from the source computing entity, a confirmation to execute the secure interaction in response to a source confirmation query; and
receiving, from the destination computing entity, a confirmation to execute the secure interaction in response to a destination confirmation query.

11. A digital memory device comprises:
a first digital data storage section that stores operational instructions that, when executed by a source computing entity or by a destination computing entity, causes the source computing entity or the destination computing entity to:
initiate a secure interaction with the other of the source computing entity or the destination computing entity, wherein:
the initiating the secure interaction includes informing, by the source computing entity or by the destination computing entity, an interaction computing entity of the initiated secure transaction; and
the secure interaction is regarding something of value; and
a second digital data storage section that stores operational instructions that, when executed by the interaction computing entity, causes the interaction computing entity to:
determine user preferences associated with the source computing entity based on a set of source inputs associated with the source computing entity, wherein:
the set of source inputs is digital information regarding the source computing entity and/or the secure interaction, and
the user preferences include identify of a cryptocurrency digital asset for which the source computing entity is offering to pay for the something of value;
determine merchant preferences associated with the destination computing entity, wherein the merchant preferences include a preferred digital asset payment type;
establish digital asset exchange parameters for the secure interaction based on the user preferences and on the merchant preferences; and
facilitate the secure interaction between the source computing entity and the destination computing entity based on the digital asset exchange parameters when the digital asset exchange parameters were confirmed by the source computing entity and/or the destination computing entity.

12. The digital memory device of claim 11, wherein the first digital data storage section further stores operational instructions that, when executed by the source computing entity, causes the source computing entity to initiate the securing interaction further by:
accessing a digital asset-based interaction page associated with the destination computing device, wherein the digital asset-based interaction page provides information regarding potential interactions supported by the destination computing entity.

13. The digital memory device of claim 11, wherein the first digital data storage section further stores operational instructions that, when executed by the destination computing entity, causes the destination computing entity to inform the interaction computing entity further by:
sending a set of digital asset-based interaction inputs to the interaction computing entity, wherein the set of digital asset-based interaction inputs include digital information regarding the merchant preferences, which further include:
preferred types of interactions;
preferred digital asset payment types for different types of interactions;
preferred authentical mechanisms;
special offers for selected things of value; sand
special offers for selected users via their associated source computing entities.

14. The digital memory device of claim 11, wherein the first digital data storage section further stores operational instructions that, when executed by the source computing entity, causes the source computing entity to inform the interaction computing entity further by:
sending the set of source inputs to the interaction computing entity, wherein:
the digital information regarding the source computing entity includes one or more of:
a user identifier associated with the source computing entity;
a source computing entity identifier;
a user email address associated with the source computing entity;
a user physical address associated with the source computing entity;
a list of digital assets associated with a user via the source computing entity;
a source computing entity IP address;
access token information;
a user telephone number associated with the source computing entity; and
a customer loyalty number associated with the source computing entity or with the user identifier; and
the digital information regarding the secure interaction includes one or more of:
intent to initiate the secure interaction via:
sending a digital communication regarding initiating the secure interaction, or
scanning a code regarding the secure interaction;
identity of a digital asset source;
an offer for sale amount regarding the something of value; and
identity of the something of value.

15. The digital memory device of claim 11, wherein the second digital data storage section further stores operational instructions that, when executed by the interaction computing entity, causes the interaction computing entity to determine the user preferences by:
interpreting a smart contract associated with the source computing entity, wherein the smart contract includes a plurality of purchasing preferences of a user associated with the source computing device.

16. The digital memory device of claim 11, wherein the second digital data storage section further stores operational instructions that, when executed by the interaction computing entity, causes the interaction computing entity to determine the merchant preferences by:
interpreting a smart contract associated with the destination computing entity, wherein the smart contract includes a plurality of preferences of a merchant associated with the destination computing device.

17. The digital memory device of claim 11, wherein the second digital data storage section further stores operational instructions that, when executed by the interaction computing entity, causes the interaction computing entity to establish the digital asset exchange parameters by one or more of:
establishing, as a first digital asset exchange parameter of the digital asset exchange parameters, proxy information regarding the user preferences of a user associated with the source computing entity;
establishing, as a second digital asset exchange parameter of the digital asset exchange parameters, sufficient staking of the cryptocurrency digital asset of the source computing entity for purchasing of the something of value;
establishing, as a third digital asset exchange parameter of the digital asset exchange parameters, a sales price for purchase of the something of value via the source computing entity by the associated user;
establishing, as a fourth digital asset exchange parameter of the digital asset exchange parameters, applicable customer loyalty benefits of the associated user regarding the purchasing of the something of value and/or purchasing via the destination computing entity associated with a merchant; and
establishing, as a fifth digital asset exchange parameter of the digital asset exchange parameters, an access token to ensure integrity of the secure interaction.

18. The digital memory device of claim 17, wherein the second digital data storage section further stores operational instructions that, when executed by the interaction computing entity, causes the interaction computing entity to facilitate the secure interaction by one or more of:
when sufficient staking of the cryptocurrency digital asset for the sales price for purchase of the something of value has been verified:
determining applicable customer loyalty benefits;
applying the applicable customer loyalty benefits to purchase of the something of value; and
executing the secure interaction using the proxy information regarding the associated user and/or of the source computing entity.

19. The digital memory device of claim 18, wherein the second digital data storage section further stores operational instructions that, when executed by the interaction computing entity, causes the interaction computing entity to:
verify the access token prior to verifying the sufficient staking;
when the access token is not verified, deny the secure interaction.

20. The digital memory device of claim 11, wherein the second digital data storage section further stores operational instructions that, when executed by the interaction computing entity, causes the interaction computing entity to at least one of:
receive, from the source computing entity, a confirmation to execute the secure interaction in response to a source confirmation query; and
receive, from the destination computing entity, a confirmation to execute the secure interaction in response to a destination confirmation query.
